(19) United States
(12) Patent Application Publication
(10) Pub. No.: US 2023/0324868 A1
(43) Pub. Date: Oct. 12, 2023

(54) CONTROL SYSTEM, LOCAL DEVICE, AND REMOTE DEVICE

(71) Applicant: Mitsubishi Electric Corporation, Tokyo (JP)

(72) Inventors: Koki IGAWA, Tokyo (JP); Yohei TSUKAMOTO, Tokyo (JP); Osamu TOYAMA, Tokyo (JP)

(73) Assignee: Mitsubishi Electric Corporation, Tokyo (JP)

(21) Appl. No.: 18/210,131

(22) Filed: Jun. 15, 2023

Related U.S. Application Data
(63) Continuation of application No. PCT/JP2021/005764, filed on Feb. 16, 2021.

(51) Int. Cl. G05B 19/042

(52) U.S. Cl. CPC G05B 19/042; G05B 2219/23051

(57) ABSTRACT

A control system (60) includes a state machine (13, 32) to make a state transition among a plurality of states each set with either of a remote control attribute and a local control attribute as an attribute; and an execution control unit (14, 33) to cause a remote device (30) in a remote environment for a control target device (20) to perform an output value generating process of generating an output value to the control target device (20), when the attribute of a current state of the state machine (13, 32) is the remote control attribute, and to cause a local device (10) in a local environment for the control target device (20) to perform the output value generating process, when the attribute of the current state of the state machine (13, 32) is the local control attribute.

### CROSS REFERENCE TO RELATED APPLICATION

This application is a Continuation of PCT International Application No. PCT/JP2021/005764, filed on Feb. 16, 2021, which is hereby expressly incorporated by reference into the present application.

### TECHNICAL FIELD

The present disclosure relates to control of a control target device.

### BACKGROUND ART

In recent years, a control system is often constructed in which a controller and an input/output device having an input/output function with respect to a control target having a sensor and/or actuator or the like are connected via a network. In this control system, the network between the controller and the input/output device may include, a network (such as the Internet) with a high possibility of occurrence of communication delay and/or packet loss.

If communication delay and/or packet loss occurs in a process requiring high responsiveness (realtime properties), there is a possibility that the required responsiveness is not satisfied.

As a process requiring high responsiveness, for example, the following process can be thought.
(1) The controller acquires, from a control target device having a sensor and a motor, a sensor value acquired at the sensor as an input value.
(2) When the sensor value is a specific value, the controller outputs to the control target device, an output value for stopping the motor.

Also, as a process not requiring high responsiveness, for example, the following process can be thought.
(1) The controller acquires, from a control target device having a push switch and a monitor, a state value for providing notification of a state of the push switch as an input value.
(2) Based on the state value, the controller outputs, to the control target device, an output value for causing the monitor to display the state of the push switch.

As measures against the problem in which the required responsiveness is not satisfied due to communication delay and/or packet loss, the following can be thought.

For example, the input/output device is provided with a function of detecting communication error such as timeout, in consideration of the required responsiveness. Also, when the function detects communication error, the function performs error handling such as a fail-safe process.

However, if the frequency of detection of communication error is high, error handling frequently occurs. Thus, if the frequency of detection of communication error is high, availability of the control system is decreased.

Meanwhile, there is a method of performing a specific process near the control target device.

For example, in Patent Literature 1, a control system is disclosed in which a process requiring high responsiveness is performed by a local device in a factory and a process not requiring high responsiveness is performed by a remote device in a management center via the Internet.

### CITATION LIST

### Patent Literature

Patent Literature 1: JP 2002-82711

### SUMMARY OF INVENTION

### Technical Problem

When a state machine is used for control of the control target device, a process to be performed varies depending on each state. Also, the order of performing process varies depending on the situation of a state transition. In control of the control target device, an output value generating process of generating an output value to the control target device is performed. Therefore, when a state machine is used for control of the control target device, the output value generating process to be performed varies depending on each state, and the order of performing the output value generating processes varies depending on the situation of a state transition.

In the scheme of Patent Literature 1, processes are fixedly allocated to the remote device and the local device. Thus, in the scheme of Patent Literature 1, there is a problem in which the device to be caused to perform the output value generating process cannot be switched between the remote device and the local device for each state in accordance with the state transition.

A main object of the present disclosure is to solve the above-described problem. More specifically, a main object of the present disclosure is to switch the device to be caused to perform the output value generating process between the remote device and the local device for each state in accordance with the state transition.

### Solution to Problem

A control system according to the present disclosure includes:
a state machine to make a state transition among a plurality of states each set with either of a remote control attribute and a local control attribute as an attribute; and
an execution control unit to cause a remote device in a remote environment for a control target device to perform an output value generating process of generating an output value to the control target device, when the attribute of a current state of the state machine is the remote control attribute, and to cause a local device in a local environment for the control target device to perform the output value generating process, when the attribute of the current state of the state machine is the local control attribute.

### Advantageous Effects of Invention

According to the present disclosure, the device to be caused to perform the output value generating process can be switched between the remote device and the local device for each state in accordance with the state transition.

### BRIEF DESCRIPTION OF DRAWINGS

FIG. 1 is a diagram illustrating an example of structure of a control system according to Embodiment 1.

FIG. 2 is a diagram illustrating an example of a state machine according to Embodiment 1.

FIG. 3 is a diagram illustrating an example of an initial setting packet according to Embodiment 1.

FIG. 4 is a diagram illustrating an example of an input packet according to Embodiment 1.

FIG. 5 is a diagram illustrating an example of an output packet according to Embodiment 1.

FIG. 6 is a diagram illustrating an example of a local control status packet according to Embodiment 1.

FIG. 7 is a diagram illustrating an example of a state attribute table according to Embodiment 1.

FIG. 8 is a diagram illustrating an example of functional structure of an input/output device according to Embodiment 1.

FIG. 9 is a diagram illustrating an example of functional structure of a controller according to Embodiment 1.

FIG. 10 is a flowchart illustrating an example of an initializing process according to Embodiment 1.

FIG. 11 is a flowchart illustrating an example of an input process of the input/output device according to Embodiment 1.

FIG. 12 is a flowchart illustrating an example of operation of the controller according to Embodiment 1.

FIG. 13 is a flowchart illustrating an example of operation of the input/output device according to Embodiment 1.

FIG. 14 is a flowchart illustrating the example of operation of the input/output device according to Embodiment 1.

FIG. 15 is a diagram describing effects according to Embodiment 1.

FIG. 16 is a diagram illustrating an example of structure of a control system according to Embodiment 2.

FIG. 17 is a flowchart illustrating an example of a local input process according to Embodiment 2.

FIG. 18 is a flowchart illustrating an example of operation of an input/output device according to Embodiment 2.

FIG. 19 is a flowchart illustrating the example of operation of the input/output device according to Embodiment 2.

FIG. 20 is a diagram illustrating an example of structure of a control system according to Embodiment 3.

FIG. 21 is a diagram illustrating an example of functional structure of a gateway according to Embodiment 3.

FIG. 22 is a flowchart illustrating an example of an input process of the gateway according to Embodiment 3.

FIG. 23 is a flowchart illustrating an example of operation of the gateway according to Embodiment 3.

FIG. 24 is a flowchart illustrating an example of an initializing process according to Embodiment 4.

FIG. 25 is a diagram illustrating an example of hardware structure of the input/output device according to Embodiment 1.

FIG. 26 is a diagram illustrating an example of hardware structure of the controller according to Embodiment 1.

FIG. 27 is a diagram illustrating an example of hardware structure of the gateway according to Embodiment 3.

### DESCRIPTION OF EMBODIMENTS

In the following, embodiments are described by using the drawings. In the description of the embodiments below and the drawings, a portion provided with the same reference character illustrates the same portion or corresponding portion.

### Embodiment 1

***Description of Structure***

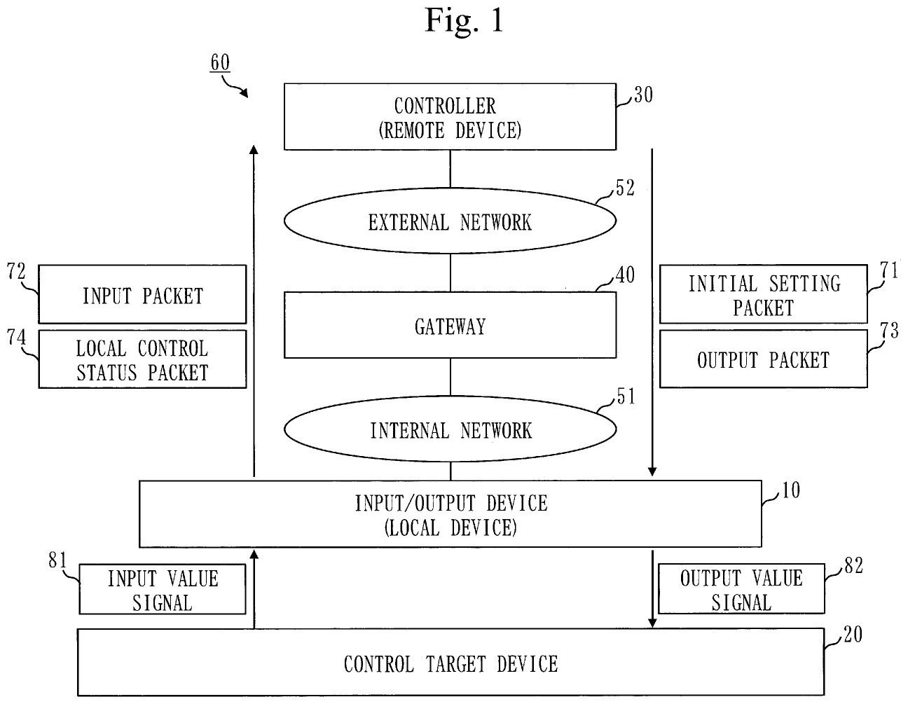

FIG. 1 illustrates an example of structure of a control system 60 according to the present embodiment.

The control system 60 according to the present embodiment includes an input/output device 10 and a controller 30. Operation to be performed in the input/output device 10 and the controller 30 corresponds to a control method.

The control system 60 is a system for controlling a control target device 20.

The input/output device 10 is a device in a local environment for the control target device 20. The input/output device 10 corresponds to a local device. Also, the operation procedure of the input/output device 10 corresponds to a signal processing method.

The local environment for the control target device 20 is an environment in which communication delay and jitter occurring in communication with the control target device 20 are within an allowable range and prediction of worst values of the communication delay and the jitter is not difficult. In the present embodiment, the input/output device 10 is directly connected to the control target device 20. Thus, between the input/output device 10 and the control target device 20, communication delay and jitter hardly occur. Also, even if communication delay and jitter occur, prediction of worst values of communication delay and jitter is easy. Therefore, the input/output device 10 is present in a local environment for the control target device 20. While an example is illustrated in the present embodiment in which the input/output device 10 and the control target device 20 are directly connected together, the input/output device 10 and the control target device 20 may be connected together via a communication line where communication delay and jitter are within an allowable range and prediction of worst values of the communication delay and the jitter is not difficult.

The input/output device 10 receives an initial setting packet 71 transmitted from the controller 30, via an internal network 51 from a gateway 40. The initial setting packet 71 is for use in an initializing process of the input/output device 10.

The input/output device 10 repeatedly receives an input value signal 81 from the control target device 20. By the input value signal 81, notification of an input value from the control target device 20 is provided.

Also, whenever receiving the input value signal 81 from the control target device 20, the input/output device 10 transmits an input packet 72 via the internal network 51 to the gateway 40. By the input packet 72, notification of the input value from the control target device 20 is provided.

Also, the input/output device 10 transmits a local control status packet 74 via the internal network 51 to the gateway 40.

By the local control status packet 74, notification of a state transition destination, which will be described further below, and an updated value of a shared internal value is provided.

The shared internal value is an internal value shared between the input/output device 10 and the controller 30. The shared internal value is a value required when arithmetic operation is performed at a primitive state machine and a local state machine, which will be described further below. The input/output device 10 and the controller 30 are required to synchronically update the shared internal value.

Also, the input/output device 10 receives an output packet 73 transmitted from the controller 30, via the internal network 51 from the gateway 40. By the output packet 73, notification of an output value to the control target device 20, a state transition destination, and an updated value of the shared internal value is provided.

Also, the input/output device 10 transmits an output value signal 82 to the control target device 20. By the output value signal 82, notification of the output value to the control target device 20 is provided.

The control target device 20 is, for example, a device having a sensor and an actuator.

The input value of which notification is provided by the input value signal 81 is, for example, a sensor value acquired by the sensor. Also, the output value of which notification is provided by the output value signal 82 is, for example, a control value for controlling the actuator.

Also, when the control target device 20 has a push switch and a monitor, the input value of which notification is provided by the input value signal 81 may be a state value which provides notification of a state of the push switch. Also, the output value of which notification is provided by the output value signal 82 may be a value for causing the monitor to display a state of the push switch.

The controller 30 is a device in a remote environment for the control target device 20. The controller 30 corresponds to a remote device. Also, the operation procedure of the controller 30 corresponds to a packet processing method.

The remote environment for the control target device 20 is an environment in which communication delay and jitter occurring in communication with the control target device 20 are outside an allowable range and prediction of worst values of the communication delay and the jitter is difficult. The controller 30 is connected via the input/output device 10, the internal network 51, the gateway 40, and an external network 52 to the control target device 20. Thus, communication delay and jitter occurring in communication between the controller 30 and the control target device 20 are large, and prediction of worst values of occurring communication delay and jitter is difficult. Therefore, the controller 30 is present in a remote environment for the control target device 20.

The gateway 40 is connected via the internal network 51 to the input/output device 10, and is connected via the external network 52 to the controller 30.

The gateway 40 relays, between the input/output device 10 and the controller 30, communication of the initial setting packet 71, the input packet 72, the output packet 73, and the local control status packet 74.

The internal network 51 is a communication path in which only an assumed traffic is present, communication delay and jitter are within an allowable range, and prediction of worst values of communication delay and jitter is easy. The internal network 51 is, for example, a field network.

The external network 52 is a communication path in which an unassumed traffic may be present, communication delay and jitter are outside an allowable range, and prediction of worst values of communication delay and jitter is difficult. The external network 52 is, for example, the Internet.

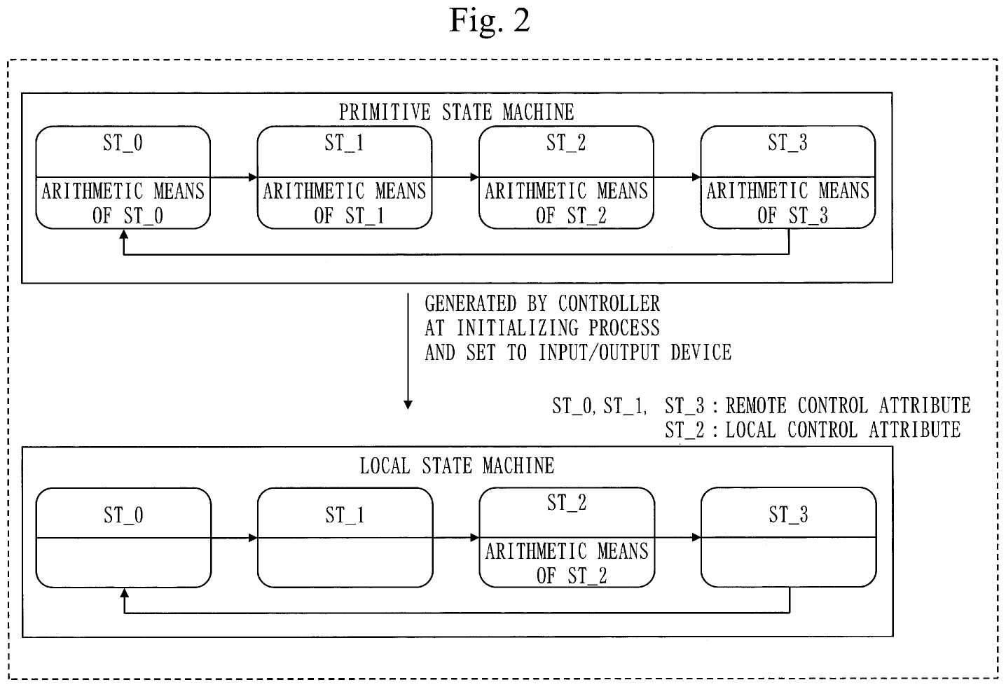

FIG. 2 illustrates an example of a state machine for use in the present embodiment.

State machines for use in the present embodiment include a primitive state machine and a local state machine.

The primitive state machine is a state machine to be managed by the controller 30. The primitive state machine corresponds to a remote state machine.

The local state machine is a state machine to be managed by the input/output device 10.

The primitive state machine is a state machine in which a plurality of states with defined control specifications are included. The primitive state machine makes a state transition among the plurality of states.

Also, in each of the plurality of states included in the primitive state machine, either of a remote control attribute and a local control attribute is set as an attribute. For example, when the number of states included in the primitive state machine is N (N≥2), L (1≤L<N) states each having a local control attribute and (N−L) states each having a remote control attribute are present in the primitive state machine.

Also, in each state of the primitive state machine, arithmetic means is included. Each arithmetic means performs arithmetic operation using an input value and a shared internal value. Each arithmetic means acquires, via arithmetic operation, a state transition destination, an output value, and an updated value of the shared internal value.

The controller 30 causes the state of the primitive state machine to make a transition to the state transition destination acquired by the arithmetic operation of the arithmetic means. Furthermore, the controller 30 may cause the state of the primitive state machine to make a transition to the state transition destination of which notification is provided from the input/output device 10.

Also, in each state, a required response time is specified. The required response time is a time required in the input/output device 10 from reception of an input value from the control target device 20 to transmission of an output value to the control target device 20.

Note that, based on the required response time of each state, the controller 30 may set the attribute of each state as either of the remote control attribute and the local control attribute.

The local state machine includes a plurality of states identical to the plurality of states included in the primitive state machine. The local state machine makes a state transition in synchronization with the primitive state machine.

Also, in the local state machine, an attribute identical to that of the corresponding state of the primitive state machine is set in each state. That is, as with the primitive state machine, L states each having a local control attribute and (N−L) states each having a remote control attribute are present also in the local state machine.

In the local state machine, arithmetic means is included only in a state having a local control attribute. Arithmetic means is not included in a state having a remote control attribute. The arithmetic means of the state having the local control attribute in the local state machine performs operation similar to that of the arithmetic means of the corresponding state in the primitive state machine.

When acquiring a state transition destination from the arithmetic operation of the arithmetic means, the input/output device 10 causes the state of the primitive state machine to make a transition to the state transition destination acquired by the arithmetic operation of the arithmetic means. Also, the input/output device 10 may cause the state of the primitive state machine to make a transition to the state transition destination of which notification is provided from the controller 30.

Here, the remote control attribute and the local control attribute are described.

The remote control attribute is an attribute with an output value generating process, a state transition destination specifying process, and a shared internal value updating process performed by the arithmetic means of the primitive state machine. On the other hand, the local control attribute is an attribute with an output value generating process, a state transition destination specifying process, and a shared internal value updating process performed by the arithmetic means of the local state machine.

The output value generating process is a process of generating an output value to the control target device 20 based on the input value from the control target device 20. Note that the output value generating process may be a process of generating an output value to the control target device 20 based on the shared internal value in addition to the input value. The state transition destination specifying process is a process of specifying state transition destinations of the primitive state machine and the local state machine. The shared internal value updating process is a process of updating the shared internal value at the input/output device 10 and the controller 30.

In the example of FIG. 2, in the primitive state machine, four states, that is, ST_0, ST_1, ST_2, and ST_3, are included. And, a remote control attribute is set to ST_0, ST_1, and ST_3, and a local control attribute is set to ST_2. In the primitive state machine, arithmetic means is present in each of ST_0, ST_1, ST_2, and ST_3.

As with the local state machine, four states, that is, ST_0, ST_1, ST_2, and ST_3, are included, but arithmetic means is present only in ST_2 where a local control attribute is set.

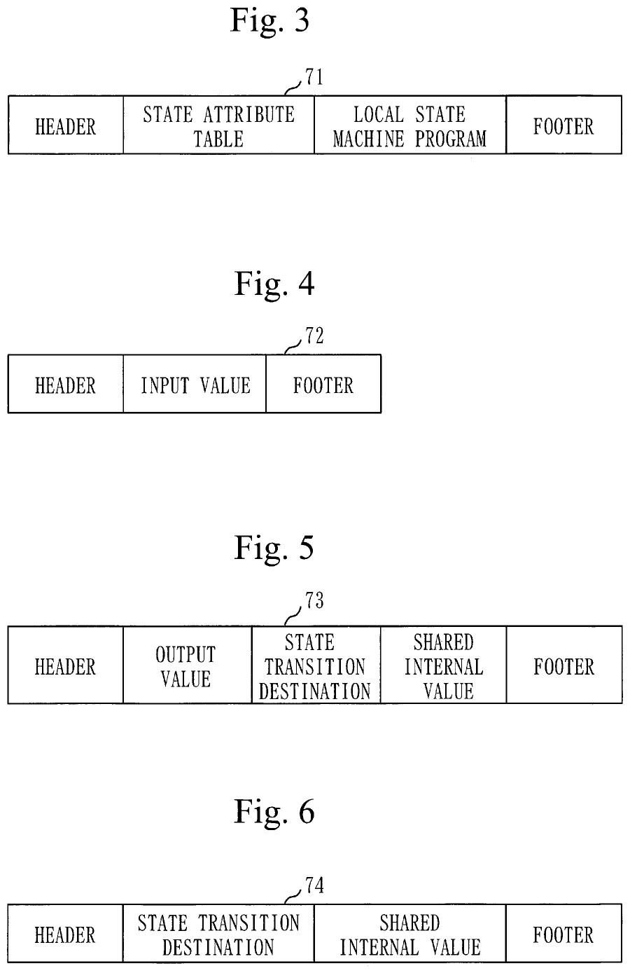

FIG. 3 illustrates an example of the initial setting packet 71.

As described above, the initial setting packet 71 is transmitted from the controller 30 to the input/output device 10.

In the initial setting packet 71, a header, a state attribute table, a local state machine program, and a footer are included.

The state attribute table is a table indicating an attribute of each state included in the primitive state machine and the local state machine.

The local state machine program is a program realizing arithmetic means of the state having the local control attribute. That is, the local state machine program is a program for causing the local state machine to execute the output value generating process, the state transition destination specifying process, and the shared internal value updating process.

The local state machine program is generated at the controller 30.

FIG. 4 illustrates an example of the input packet 72.

As described above, the input packet 72 is transmitted from the input/output device 10 to the controller 30.

In the input packet 72, a header, an input value, and a footer are included.

The input value is a value of which notification is provided by the input value signal 81.

FIG. 5 illustrates an example of the output packet 73.

As described above, the output packet 73 is transmitted from the controller 30 to the input/output device 10.

In the output packet 73, a header, an output value, a state transition destination, a shared internal value, and a footer are included.

When the attribute of the current state of the primitive state machine and the local state machine is a remote control attribute, by the output packet 73, notification of the output value, the state transition destination, and the updated value of the shared internal value acquired by the arithmetic operation of the arithmetic means of the primitive state machine is provided. Note that when the shared internal value is not updated, the shared internal value may not be included in the output packet 73.

FIG. 6 illustrates an example of the local control status packet 74.

As described above, the local control status packet 74 is transmitted from the input/output device 10 to the controller 30.

In the local control status packet 74, a header, a state transition destination, a shared internal value, and a footer are included.

When the attribute of the current state of the primitive state machine and the local state machine is a local control attribute, by the local control status packet 74, notification of the state transition destination and the updated value of the shared internal value acquired by the arithmetic operation of the arithmetic means of the local state machine is provided. Note that when the shared internal value is not updated, the shared internal value may not be included in the local control status packet 74.

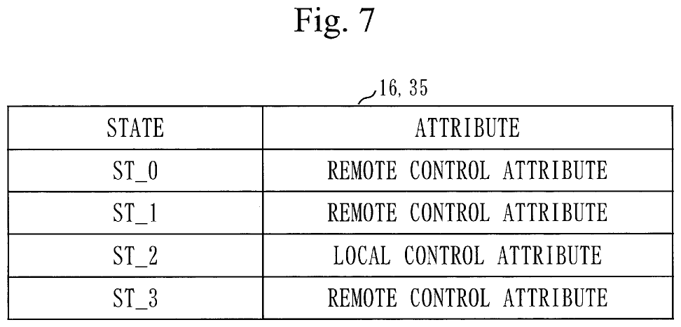

FIG. 7 illustrates an example of a state attribute table.

As described above, the state attribute table is a table indicating an attribute of each state included in the primitive state machine and the local state machine.

In the example of FIG. 7, four states, that is, ST_0, ST_1, ST_2, and ST_3, illustrated in FIG. 2 and the attribute of each state are illustrated.

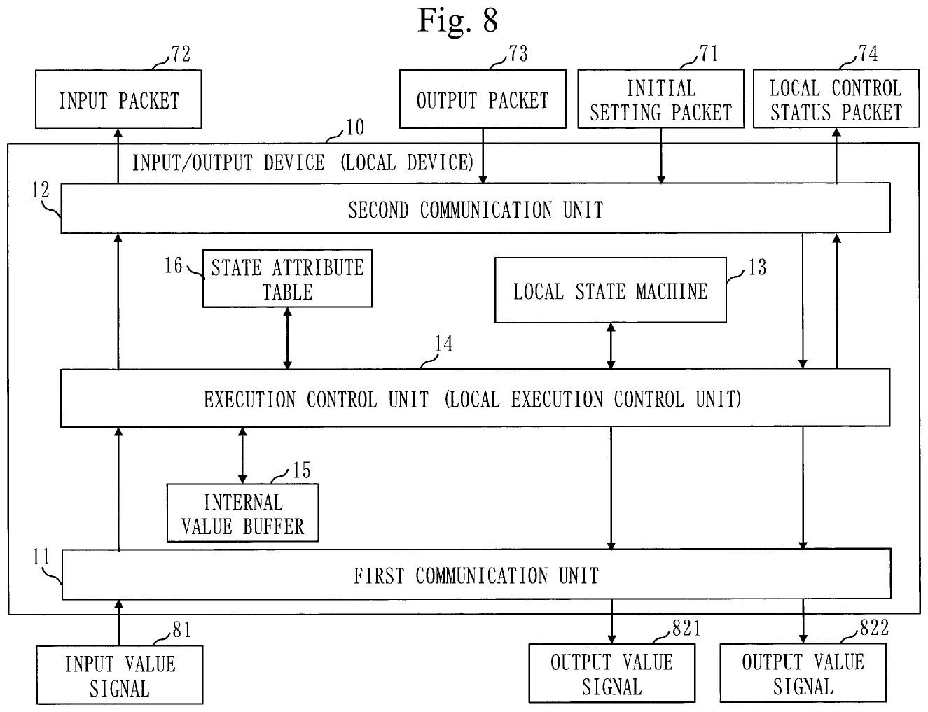

FIG. 8 illustrates an example of functional structure of the input/output device 10 according to the present embodiment.

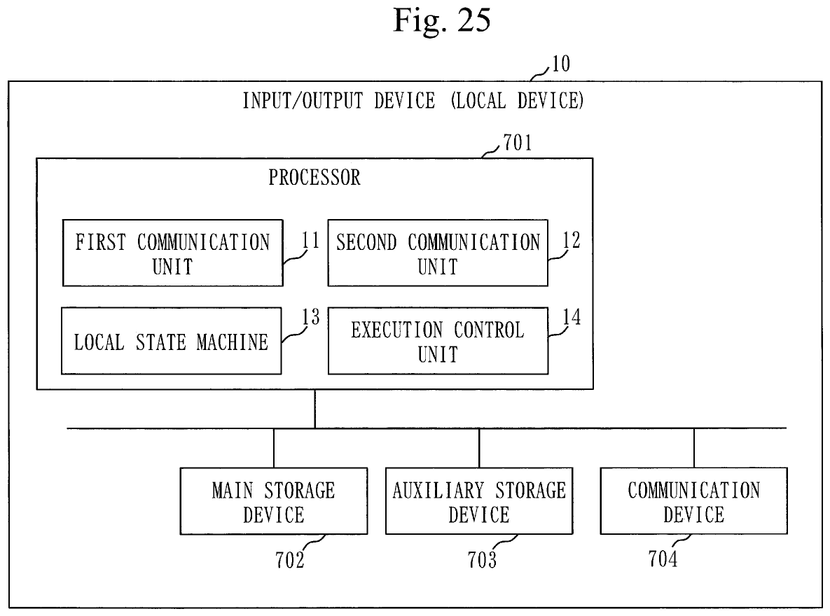

FIG. 25 illustrates an example of hardware structure of the input/output device 10.

First, with reference to FIG. 25, the example of hardware structure of the input/output device 10 is described.

The input/output device 10 according to the present embodiment is a computer.

The input/output device 10 includes, as hardware, a processor 701, a main storage device 702, an auxiliary storage device 703, and a communication device 704.

In the auxiliary storage device 703, programs realizing the functions of a first communication unit 11, a second communication unit 12, a local state machine 13, and an execution control unit 14, which will be described further below with reference to FIG. 8, are stored. Note that the programs realizing the functions of the first communication unit 11, the second communication unit 12, and the execution control unit 14 correspond to a signal processing program.

These programs are loaded from the auxiliary storage device 703 to the main storage device 702. Then, the processor 701 executes these programs to perform operations of the first communication unit 11, the second communication unit 12, the local state machine 13, and the execution control unit 14, which will be described further below.

In FIG. 25, a state is schematically illustrated in which the processor 701 is executing the programs realizing the functions of the first communication unit 11, the second communication unit 12, the local state machine 13, and the execution control unit 14.

Note that the programs realizing the functions of the local state machine 13 and the execution control unit 14 and programs realizing the functions of a primitive state machine 32 and an execution control unit 33, which will be described further below, correspond to a control program.

Next, with reference to FIG. 8, the example of functional structure of the input/output device 10 is described.

The first communication unit 11 communicates with the control target device 20.

Specifically, by using the communication device 704, the first communication unit 11 receives the input value signal 81 from the control target device 20. Also, by using the communication device 704, the first communication unit 11 transmits an output value signal 821 or an output value signal 822 to the control target device 20. The output value signal 821 is a signal for providing notification of an output value generated by the local state machine 13, which will be described further below. On the other hand, the output value signal 822 is a signal for providing notification of an output value generated by the controller 30.

Note that the process to be performed by the first communication unit 11 corresponds to a first communication process.

The second communication unit 12 communicates with the gateway 40 via the internal network 51.

Specifically, by using the communication device 704, the second communication unit 12 transmits the input packet 72 and the local control status packet 74 to the gateway 40.

Also, by using the communication device 704, the second communication unit 12 receives the initial setting packet 71 and the output packet 73 from the gateway 40.

Note that the process to be performed by the second communication unit 12 corresponds to a second communication process.

The local state machine 13 is the local state machine described by using FIG. 2.

When the attribute of the current state of the state machine (local state machine 13) is a remote control attribute, the execution control unit 14 causes the remote device (controller 30) in a remote environment for the control target device 20 to execute the output value generating process of generating an output value to the control target device 20. On the other hand, when the attribute of the current state of the state machine (local state machine 13) is a local control attribute, the execution control unit 14 causes the local device (input/output device 10) in a local environment for the control target device 20 to execute the output value generating process.

Also, the execution control unit 14 acquires the initial setting packet 71 from the second communication unit 12.

Then, the execution control unit 14 sets the local state machine program included in the initial setting packet 71 to the local state machine 13. That is, the execution control unit 14 causes the local state machine program to be implemented in the main storage device 702 so that the local state machine 13 can execute the local state machine program. With the execution control unit 14 setting the local state machine program to the local state machine 13, the arithmetic means becomes executable.

Also, the execution control unit 14 causes the state attribute table included in the initial setting packet 71 to be implemented in the main storage device 702. A state attribute table 16 illustrated in FIG. 7 represents a state attribute table in a state of being implemented in the main storage device 702. The execution control unit 14 can refer to the state attribute table 16.

Also, the execution control unit 14 acquires the input value signal 81 from the first communication unit 11. Also, the execution control unit 14 generates, from the input value signal 81, the input packet 72 for providing notification of the input signal, and then outputs the input packet 72 to the second communication unit 12.

In this manner, the execution control unit 14 receives the input value from the control target device 20, and notifies the controller 30 of the input value from the control target device 20 using the input packet 72.

Also, the execution control unit 14 retains the input value in an input value buffer (not illustrated), which is an internal buffer, until it acquires the next input value signal 81.

Furthermore, the execution control unit 14 refers to the state attribute table 16 to determine whether the attribute of the current state of the local state machine 13 is a remote control attribute or a local control attribute. The current state of the local state machine 13 is a state of the local state machine 13 at the time of arrival of a control period T1, which will be described further below.

When the attribute of the current state of the local state machine 13 is a local control attribute, the execution control unit 14 causes the local state machine 13 to execute the output value generating process. That is, the execution control unit 14 notifies the local state machine 13 of the input value from the control target device 20, and causes the local state machine 13 to execute the output value generating process using the input value.

Then, the execution control unit 14 generates the output value signal 821 for providing notification of the output value generated at the local state machine 13, and outputs the output value signal 821 to the first communication unit 11.

Also, when the attribute of the current state of the local state machine 13 is a local control attribute, the execution control unit 14 causes the local state machine 13 to decide a state transition destination based on the input value, and causes the state of the local state machine 13 to make a transition to the state transition destination. Also, the execution control unit 14 causes the local state machine 13 to generate an updated value of the shared internal value.

Then, the execution control unit 14 generates the local control status packet 74 for providing notification of the state transition destination and the updated value of the shared internal value, and outputs the local control status packet 74 to the second communication unit 12.

In this manner, when the attribute of the current state of the local state machine 13 is a local control attribute, the execution control unit 14 notifies the controller 30 of the state transition destination and the updated value of the shared internal value.

On the other hand, when the attribute of the current state of the local state machine 13 is a remote control attribute, the execution control unit 14 acquires the output packet 73 from the second communication unit 12. Then, the execution control unit 14 generates, from the output packet 73, the output value signal 822 for providing notification of the output value to the control target device 20, and outputs the output value signal 822 to the first communication unit 11. That is, the execution control unit 14 notifies the control target device 20 of the output value.

Furthermore, the execution control unit 14 causes the state of the local state machine 13 to make a transition to the state transition destination of which notification is provided by the output packet 73. Also, the execution control unit 14 updates the shared internal value to the updated value of the shared internal value of which notification is provided by the output packet 73.

The execution control unit 14 corresponds to a local execution control unit. Also, the process to be performed by the execution control unit 14 corresponds to a local execution control process.

Also, the process to be performed by the execution control unit 14 and the execution control unit 33, which will be described further below, corresponds to an execution control process.

An internal value buffer 15 is a buffer which retains internal values including the shared internal value. Note that when no internal value is required for control of the control target device 20, the internal value buffer 15 may be omitted.

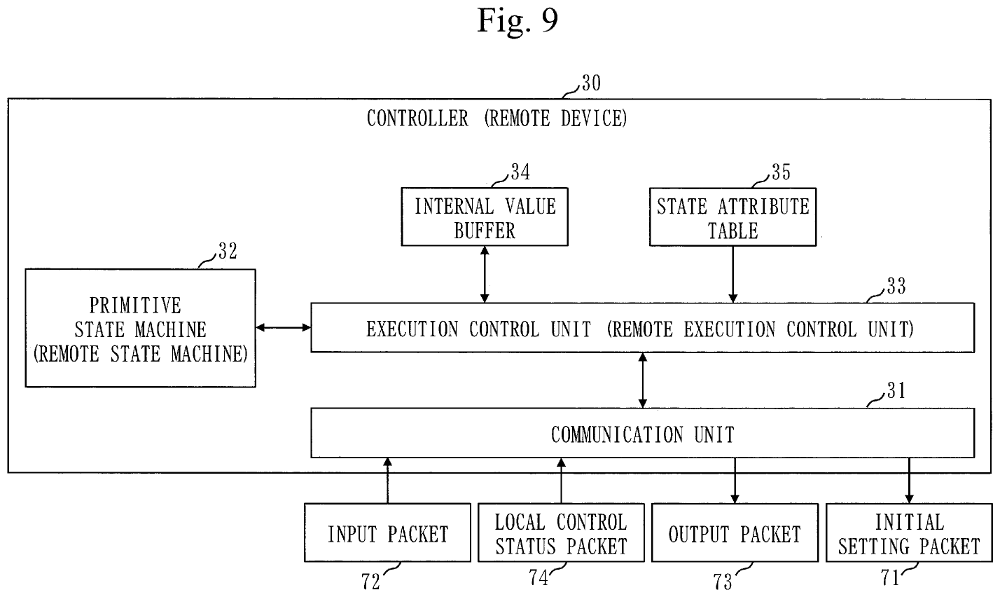

FIG. 9 illustrates an example of functional structure of the controller 30 according to the present embodiment.

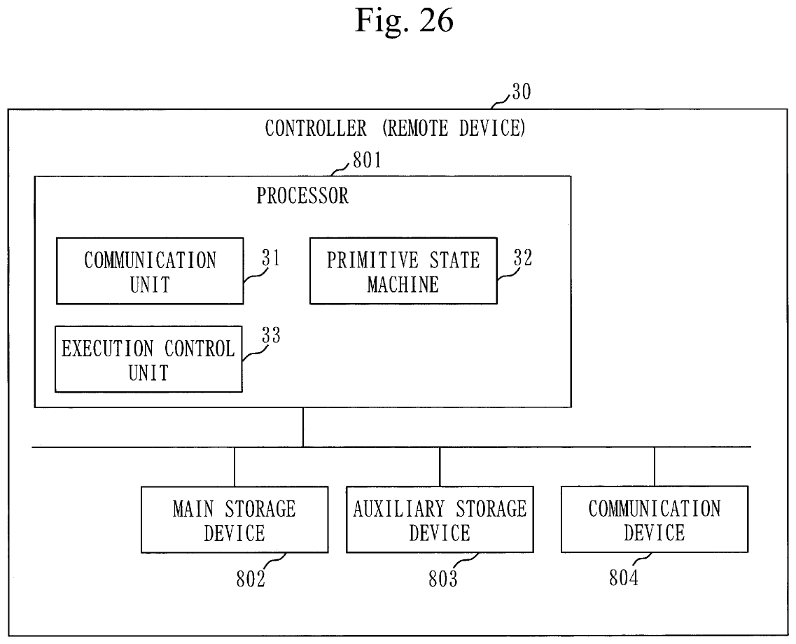

FIG. 26 illustrates an example of hardware structure of the controller 30.

First, with reference to FIG. 26, the example of hardware structure of the controller 30 is described.

The controller 30 according to the present embodiment is a computer such as a server.

The controller 30 includes, as hardware, a processor 801, a main storage device 802, an auxiliary storage device 803, and a communication device 804. Note that these pieces of hardware may be implemented as virtual hardware having equivalent functions in a virtual environment. In this case, the virtual hardware may be constructed of the plurality of computers such as a plurality of servers.

In the auxiliary storage device 803, programs realizing the functions of a communication unit 31, the primitive state machine 32, and the execution control unit 33, which will be described further below with reference to FIG. 9, are stored. The programs realizing the functions of the communication unit 31 and the execution control unit 33 correspond to a packet processing program.

These programs are loaded from the auxiliary storage device 803 to the main storage device 802. Then, the processor 801 executes these programs to perform operations of the communication unit 31, the primitive state machine 32, and the execution control unit 33, which will be described further below.

In FIG. 26, a state is schematically illustrated in which the processor 801 is executing the programs realizing the functions of the communication unit 31, the primitive state machine 32, and the execution control unit 33.

Note that as described above, the programs realizing the functions of the primitive state machine 32 and the execution control unit 33 and the programs realizing the functions of the local state machine 13 and the execution control unit 14 correspond to a control program.

Next, with reference to FIG. 9, the example of functional structure of the controller 30 is described.

The communication unit 31 communicates with the gateway 40.

Specifically, by using the communication device 804, the communication unit 31 transmits the initial setting packet 71 to the gateway 40.

Also, by using the communication device 804, the communication unit 31 receives the input packet 72 from the gateway 40.

Also, by using the communication device 804, the communication unit 31 transmits the output packet 73 to the gateway 40.

Furthermore, by using the communication device 804, the communication unit 31 receives the local control status packet 74 from the gateway 40.

The primitive state machine 32 is the primitive state machine described by using FIG. 2.

When the attribute of the current state of the state machine (primitive state machine 32) is a remote control attribute, the execution control unit 33 causes the remote device (controller 30) in a remote environment for the control target device 20 to execute the output value generating process of generating an output value to the control target device 20. On the other hand, when the attribute of the current state of the state machine (primitive state machine 32) is a local control attribute, the execution control unit 33 causes the local device (input/output device 10) in a local environment for the control target device 20 to execute the output value generating process.

The execution control unit 33 generates the initial setting packet 71.

Specifically, for N states included in the primitive state machine 32, the execution control unit 33 decides (N-L) states each having a remote control attribute and L states each having a local control attribute. Then, the execution control unit 33 generates a local state machine program realizing arithmetic means corresponding to the L local control attributes. Then, the execution control unit 33 generates the initial setting packet 71 in which the generated local state machine program and a state attribute table 35 are included, and outputs the generated initial setting packet 71 to the communication unit 31.

Also, the execution control unit 33 acquires the input packet 72 from the communication unit 31.

Then, the execution control unit 33 refers to the state attribute table 35 to determine whether the attribute of the current state of the primitive state machine 32 is a remote control attribute or a local control attribute. The current state of the primitive state machine 32 is a state of the primitive state machine 32 when the execution control unit 33 is notified of the input value from the control target device 20 (that is, when acquiring the input packet 72), or the state of the primitive state machine 32 at the time of arrival of a control period T2, which will be described further below.

When the attribute of the current state of the primitive state machine 32 is a remote control attribute, the execution control unit 33 causes the primitive state machine 32 to execute the output value generating process. That is, the execution control unit 33 notifies the primitive state machine 32 of the input value from the control target device 20, and causes the primitive state machine 32 to execute the output value generating process using the input value. Also, when the attribute of the current state of the primitive state machine 32 is a remote control attribute, the execution control unit 33 causes the primitive state machine 32 to decide a state transition destination based on the input value, and causes the state of the primitive state machine 32 to make a transition to the state transition destination. Also, the execution control unit 33 causes the primitive state machine 32 to generate an updated value of the shared internal value. Then, the execution control unit 33 generates the output packet 73 for providing notification of the output value, the state transition destination, and the updated value of the shared internal value, and outputs the output packet 73 to the communication unit 31.

In this manner, when the attribute of the current state of the primitive state machine 32 is a remote control attribute, the execution control unit 33 notifies the input/output device 10 of the output value, the state transition destination, and the updated value of the shared internal value via the gateway 40.

On the other hand, when the attribute of the current state of the primitive state machine 32 is a local control attribute, the execution control unit 33 acquires the local control status packet 74 from the communication unit 31. Then, the execution control unit 33 causes the state of the primitive state machine 32 to make a transition to the state transition destination of which notification is provided by the local control status packet 74. Also, the execution control unit 33 updates the shared internal value to the updated value of the shared internal value of which notification is provided by the local control status packet 74.

The execution control unit 33 corresponds to a remote execution control unit. Also, the process to be performed by the execution control unit 33 corresponds to a remote execution control process.

Also, the process to be performed by the execution control unit 33 and the execution control unit 14 corresponds to an execution control process.

An internal value buffer 34 is a buffer which retains internal values including the shared internal value. Note that when no internal value is required for control of the control target device 20, the internal value buffer 34 may be omitted.

The state attribute table 35 is the state attribute table illustrated in FIG. 7.

***Description of Operation***

Next, an example of operation of the controller 30 and the input/output device 10 according to the present embodiment is described.

The operation of the controller 30 and the input/output device 10 is broadly divided into operation at the initializing process and operation after the initializing process.

First, the operation at the initializing process is described.

<<Operation at Initializing Process>>

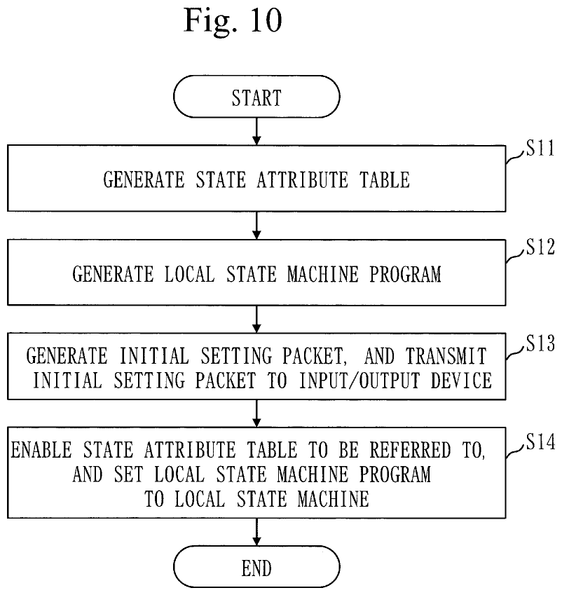

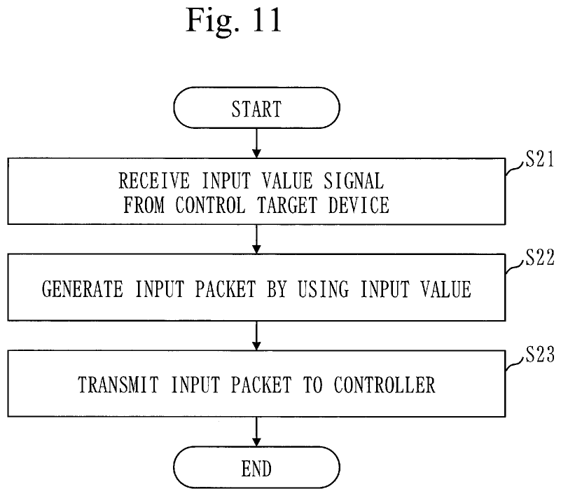

FIG. 10 illustrates the initializing process.

First, at step S11, the execution control unit 33 generates the state attribute table 35.

Specifically, the execution control unit 33 decides an attribute of each of the N states of the primitive state machine 32. For example, the execution control unit 33 sets attributes of a predetermined number of states as local control attributes in the order in which the required response time is shorter. Also, the execution control unit 33 sets attributes of the remaining states as remote control attributes. For example, among the N states, the execution control unit 33 sets attributes of L states as local control attributes and attributes of (N-L) states as remote control attributes. Then, the execution control unit 33 generates the state attribute table 35 indicating the attribute of each state.

Next, at step S12, the execution control unit 33 generates a local state machine program.

For example, the execution control unit 33 generates a program including L arithmetic means corresponding to the L states set with local control attributes as a local state machine program.

Next, at step S13, the execution control unit 33 generates the initial setting packet 71, and transmits the generated initial setting packet 71 from the communication unit 31 to the input/output device 10.

That is, the execution control unit 33 generates a packet in which the state attribute table 35 generated at step S11 and the local state machine program generated at step S12 are included as the initial setting packet 71. Then, the execution control unit 33 outputs the initial setting packet 71 to the communication unit 31, and the communication unit 31 transmits the initial setting packet 71 to the gateway 40. The gateway 40 transfers the initial setting packet 71 to the input/output device 10. Eventually, the input/output device 10 receives the initial setting packet 71 from the gateway 40.

Next, at step S14, the execution control unit 14 enables the state attribute table 35 included in the initial setting packet 71 to be referred to as the state attribute table 16. Furthermore, the execution control unit 14 sets the local state machine program included in the initial setting packet 71 to the local state machine 13.

That is, the second communication unit 12 receives the initial setting packet 71, and outputs the initial setting packet 71 to the execution control unit 14. The execution control unit 14 extracts the state attribute table 35 from the initial setting packet 71, implements the extracted state attribute table 35 in the main storage device 702, and enables it to be referred to as the state attribute table 16. Also, the execution control unit 14 extracts the local state machine program from the initial setting packet 71, implements the extracted local state machine program in the main storage device 702, enables the local state machine 13 to execute the local state machine program.

<<Operation after Initializing Process>>

Next, the operation after the initializing process is described.

FIG. 11 illustrates an example of an input process by the input/output device 10.

By using FIG. 11, the input process is described.

The flow illustrated in FIG. 11 is assumed to be started for each defined control period T1.

First, at step S21, the first communication unit 11 receives the input value signal 81 from the control target device 20.

The first communication unit 11 outputs the received input value signal 81 to the execution control unit 14.

Next, at step S22, the execution control unit 14 generates the input packet 72 by using the input value.

That is, the execution control unit 14 extracts the input value from the input value signal 81, and generates the input packet 72 by using the extracted input value. Then, the execution control unit 14 outputs the input packet 72 to the second communication unit 12.

Note that the execution control unit 14 retains the input value in an input value buffer (not illustrated), which is an internal buffer, until the next control period T1 arrives and step S22 is performed again.

Next, at step S23, the second communication unit 12 transmits the input packet 72 to the controller 30.

Specifically, the second communication unit 12 transmits the input packet 72 to the gateway 40. The gateway 40 transfers the input packet 72 to the controller 30. Eventually, the controller 30 receives the input packet 72 from the gateway 40.

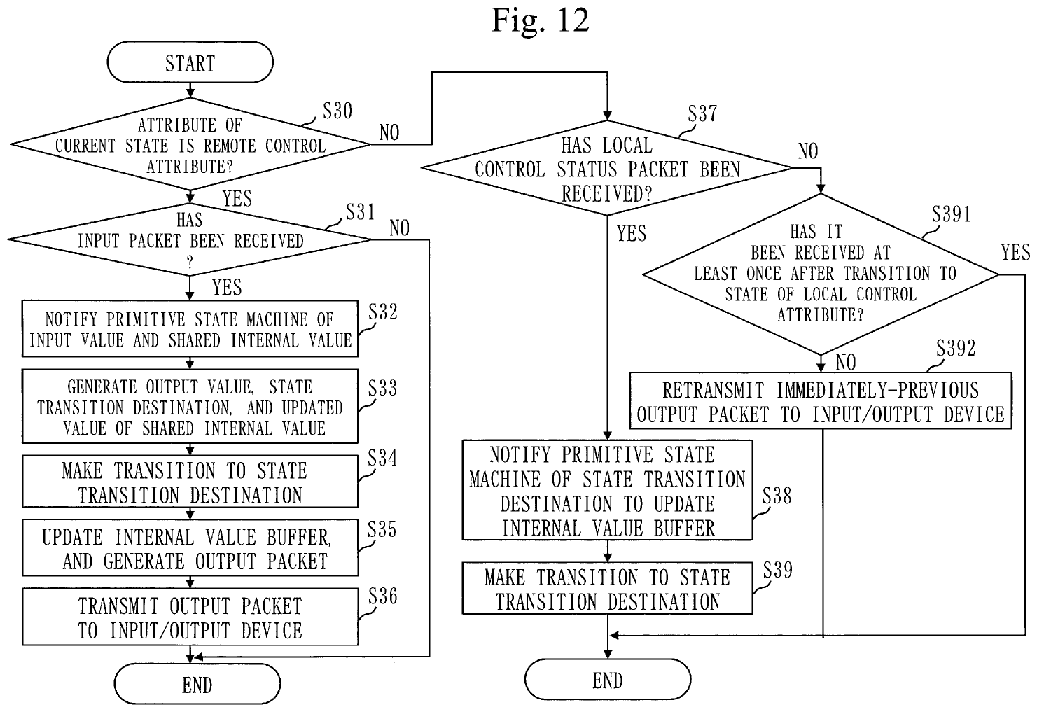

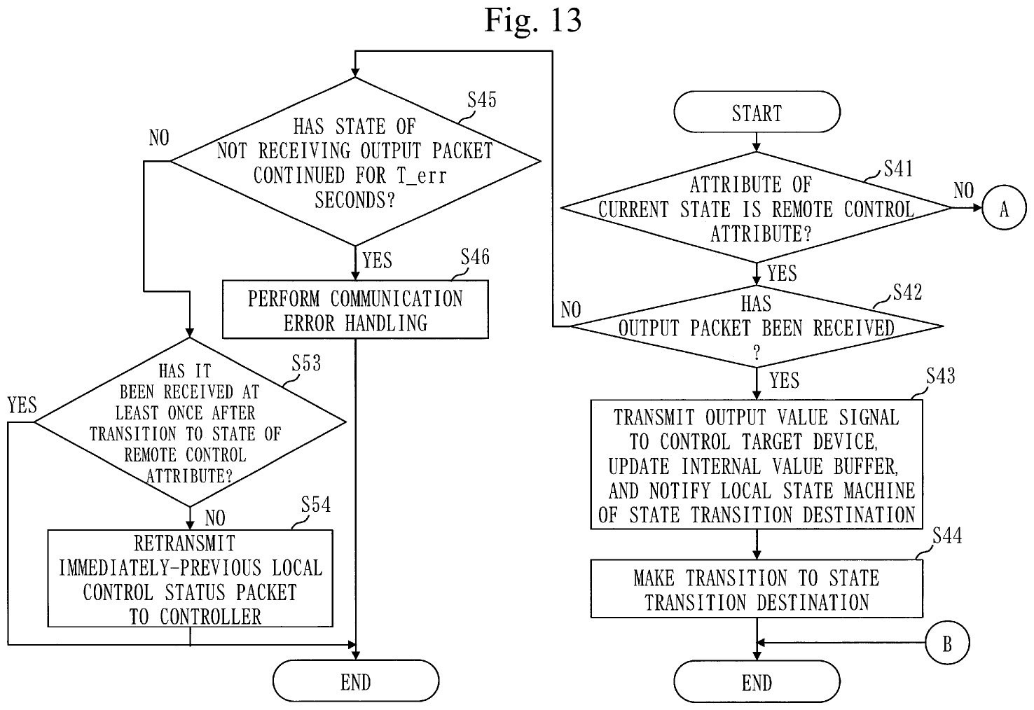

FIG. 12 illustrates an example of operation of the controller 30.

The flow of FIG. 12 is assumed to be started at reception of the input packet 72 or for each defined control period T2 (T2≤T1).

First, at step S30, the execution control unit 33 determines whether the attribute of the current state of the primitive state machine 32 is a remote control attribute.

More specifically, the execution control unit 33 refers to the state attribute table 35 to determine whether the attribute of the current state of the primitive state machine 32 is a remote control attribute. The execution control unit 33 has a state buffer (not illustrated), which is an internal buffer for recording the current state of the primitive state machine 32. Whenever a state transition occurs at the primitive state machine 32, the execution control unit 33 records the state of the state transition destination in the state buffer as the current state of the primitive state machine 32. At step S30, the execution control unit 33 determines the attribute of the current state recorded in the state buffer by referring to the state attribute table 35. For example, when the state stored in the state buffer is ST_1, the execution control unit 33 can determine from the state attribute table 35 that the attribute of the current state of the primitive state machine 32 is a remote control attribute.

When the attribute of the current state of the primitive state machine 32 is a remote control attribute, the process proceeds to step S31. On the other hand, when the attribute of the current state of the primitive state machine 32 is a local control attribute, the process proceeds to step S37.

At step S31, the execution control unit 33 determines whether the input packet 72 from the input/output device 10 has been received. That is, the execution control unit 33 determines whether the input packet 72 has been acquired from the communication unit 31.

If the input packet 72 from the input/output device 10 has been received, the process proceeds to step S32. On the other hand, if the input packet 72 from the input/output device 10 has not been received, the process ends.

At step S32, the execution control unit 33 notifies the primitive state machine 32 of the input value from the control target device 20 and the shared internal value.

That is, the execution control unit 33 notifies the primitive state machine 32 of the input value included in the input packet 72 and the shared internal value retained in the internal value buffer 34.

Next, at step S33, the primitive state machine 32 executes arithmetic means corresponding to the current state to generate an output value, a state transition destination, and an updated value of the shared internal value by using the input value of which notification is provided from the execution control unit 33 and the shared internal value.

Also, the primitive state machine 32 notifies the execution control unit 33 of the output value, the state transition destination, and the updated value of the shared internal value.

Next, at step S34, the primitive state machine 32 causes the state to make a transition to the state transition destination generated at step S33.

Next, at step S35, the execution control unit 33 updates the internal value buffer 34 by using the updated value of the shared internal value, and also generates the output packet 73 for providing notification of the output value, the state transition destination, and the updated value of the shared internal value.

Then, the execution control unit 33 outputs the output packet 73 to the communication unit 31.

Also, the execution control unit 33 updates the current state of the state buffer to the state of the state transition destination.

Next, at step S36, the communication unit 31 transmits the output packet 73 to the input/output device 10.

Specifically, the communication unit 31 transmits the output packet 73 to the gateway 40. The gateway 40 transfers the output packet 73 to the input/output device 10. Eventually, the input/output device 10 receives the output packet 73 from the gateway 40.

In this manner, when the attribute of the current state of the primitive state machine 32 is a remote control attribute, the execution control unit 33 notifies the primitive state machine 32 of the input value and the shared internal value, thereby causing the primitive state machine 32 to generate the output value, the state transition destination, and the updated value of the shared internal value and also causing the primitive state machine 32 to cause the state to make a transition to the state transition destination. Furthermore, the execution control unit 33 transmits, to the input/output device 10, the output packet 73 for providing notification of the output value, the state transition destination, and the updated value of the shared internal value generated by the primitive state machine 32.

When it is determined at step S30 that the attribute of the current state of the primitive state machine 32 is a local control attribute, at step S37, the execution control unit 33 determines whether the local control status packet 74 has been received.

That is, the execution control unit 33 determines whether the local control status packet 74 has been acquired from the communication unit 31.

If the local control status packet 74 has been received, the process proceeds to step S38. On the other hand, if the local control status packet 74 has not been received, the process proceeds to step S391.

At step S391, the execution control unit 33 determines whether the local control status packet 74 has been received at least once after a transition is made from the state of the remote control attribute to the state of the local control attribute. If the local control status packet 74 has not been received once, the process proceeds to step S392. If the local control status packet 74 has been received at least once, the process ends.

At step S392, the execution control unit 33 again transmits, to the input/output device 10, the output packet 73 generated in the state of the immediately-previous remote control attribute. Note that the output packet 73 is assumed to have been buffered for this process. After step S392, the process ends.

At step S38, the execution control unit 33 notifies the primitive state machine 32 of the state transition destination indicated in the local control status packet 74.

Also, the execution control unit 33 updates the internal value buffer 34 with the updated value of the shared internal value indicated in the local control status packet 74.

Also, the execution control unit 33 updates the current state of the state buffer to the state of the state transition destination.

Next, at step S39, the primitive state machine 32 causes the state to make a transition to the state transition destination of which notification is provided from the execution control unit 33.

In this manner, when the attribute of the current state of the primitive state machine 32 is a local control attribute, the execution control unit 33 notifies the primitive state machine 32 of the state transition destination decided at the input/output device 10, thereby causing the primitive state machine 32 to cause the state to make a transition to the state transition destination decided at the input/output device 10. Furthermore, the execution control unit 33 updates the internal value buffer 34 by using the updated value of the shared internal value decided at the input/output device 10.

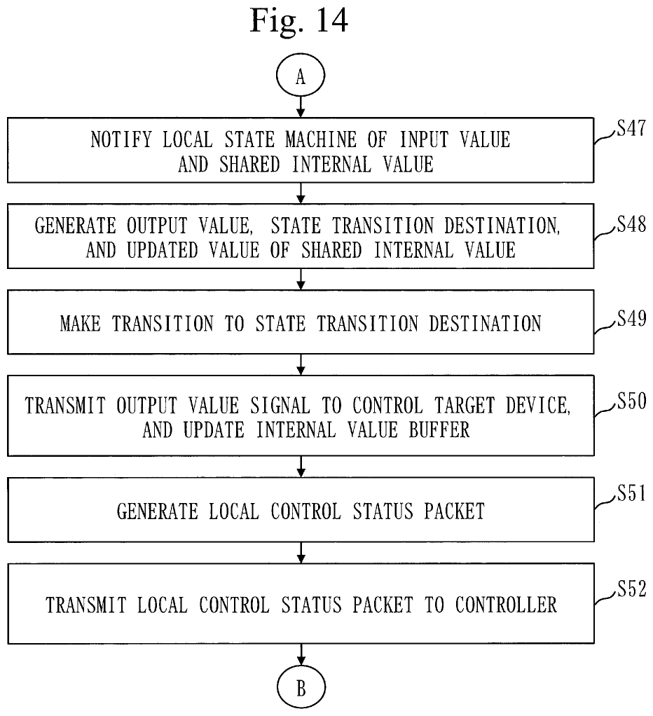

FIG. 13 and FIG. 14 illustrate an example of operation of the input/output device 10.

The flows of FIG. 13 and FIG. 14 are assumed to be started for each control period T1.

First, at step S41, the execution control unit 14 determines whether the attribute of the current state of the local state machine 13 is a remote control attribute.

More specifically, the execution control unit 14 refers to the state attribute table 16 to determine whether the attribute of the current state of the local state machine 13 is a remote control attribute. The execution control unit 14 has a state buffer (not illustrated), which is an internal buffer for recording the current state of the local state machine 13. Whenever a state transition occurs at the local state machine 13, the execution control unit 14 records the state of the state transition destination in the state buffer as the current state of the local state machine 13. At step S41, the execution control unit 14 determines the attribute of the current state recorded in the state buffer by referring to the state attribute table 16. For example, when the state stored in the state buffer is ST_1, the execution control unit 14 can determine from the state attribute table 16 that the attribute of the current state of the local state machine 13 is a remote control attribute.

When the attribute of the current state of the local state machine 13 is a remote control attribute, the process proceeds to step S42. On the other hand, when the attribute of the current state of the local state machine 13 is a local control attribute, the process proceeds to step S47 of FIG. 14.

At step S42, the execution control unit 14 determines whether the output packet 73 from the controller 30 has been received. That is, the execution control unit 14 determines whether the output packet 73 has been acquired from the second communication unit 12.

If the output packet 73 from the controller 30 has been received, the process proceeds to step S43. On the other hand, if the output packet 73 from the controller 30 has not been received, the process proceeds to step S45.

At step S43, the execution control unit 14 outputs the output value signal 822 to the control target device 20, updates the internal value buffer 15, and notifies the local state machine 13 of the state transition destination.

That is, the execution control unit 14 generates the output value signal 822 for providing notification of the output value included in the output packet 73, and outputs the generated output value signal 822 to the first communication unit 11. Then, the first communication unit 11 transmits the output value signal 822 to the control target device 20.

Also, the execution control unit 14 updates the internal value buffer 15 by using the updated value of the shared internal value included in the output packet 73.

Furthermore, the execution control unit 14 notifies the local state machine 13 of the state transition destination included in the output packet 73.

Next, at step S44, the local state machine 13 causes the state to make a transition to the state transition destination of which notification is provided from the execution control unit 14.

Also, at step S45, the execution control unit 14 determines whether a state of not receiving the output packet 73 has continued for T_err seconds.

If the state of not receiving the output packet 73 has continued for T_err seconds, the process proceeds to step S46. On the other hand, if the state of not receiving the output packet 73 has continued for less than T_err seconds, the process proceeds to step S53.

At step S53, the execution control unit 14 determines whether the output packet 73 has been received at least once after a transition is made from the state of the local control attribute to the state of the remote control attribute. If the output packet 73 has not been received once, the process proceeds to step S54. If the output packet 73 has been received at least once, the process ends.

At step S54, the execution control unit 14 again transmits the local control status packet 74 generated in the state of the immediately-previous local control attribute to the controller 30. Note that the local control status packet 74 is assumed to have been buffered for this process. After step S54, the process ends.

At step S46, the execution control unit 14 performs defined communication error handling. The communication error handling is, for example, a fail-safe process such as emergency stop.

In this manner, when the attribute of the current state of the local state machine 13 is a remote control attribute, the execution control unit 14 notifies the local state machine 13 of the state transition destination decided at the controller 30, thereby causing the local state machine 13 to cause the state to make a transition to the state transition destination decided at the controller 30. Furthermore, the execution control unit 14 updates the internal value buffer 15 by using the updated value of the shared internal value decided at the controller 30.

When it is determined at step S41 that the attribute of the current state of the local state machine 13 is a local control attribute, at step S47, the execution control unit 14 notifies the local state machine 13 of the input value from the control target device 20 and the shared internal value.

That is, the execution control unit 14 notifies the local state machine 13 of the input value included in the input value signal 81 received from the control target device 20 at step S21 of FIG. 11 and the shared internal value retained in the internal value buffer 15. The input value is a value retained in the input value buffer (not illustrated).

At step S48, the local state machine 13 executes arithmetic means corresponding to the current state to generate an output value, a state transition destination, and an updated value of the shared internal value by using the input value of which notification is provided from the execution control unit 14 and the shared internal value.

Also, the local state machine 13 notifies the execution control unit 14 of the output value, the state transition destination, and the updated value of the shared internal value.

Next, at step S49, the local state machine 13 causes the state to make a transition to the state transition destination generated at step S48.

Next, at step S50, the execution control unit 14 outputs the output value signal 821 to the control target device 20, and also updates the internal value buffer 15.

That is, the execution control unit 14 generates the output value signal 821 for providing notification of the output value generated by the local state machine 13 at step S48, and outputs the generated output value signal 821 to the first communication unit 11. Then, the first communication unit 11 transmits the output value signal 821 to the control target device 20.

Also, the execution control unit 14 updates the internal value buffer 15 by using the updated value of the shared internal value generated by the local state machine 13 at step S48.

Also, the execution control unit 14 updates the current state of the state buffer to the state of the state transition destination.

Next, at step S51, the execution control unit 14 generates the local control status packet 74.

That is, a packet for providing notification of the state transition destination and the updated value of the shared internal value generated by the local state machine 13 at step S48 is generated as the local control status packet 74. Then, the local control status packet 74 is outputted to the second communication unit 12.

Next, at step S52, the second communication unit 12 transmits the local control status packet 74 to the controller 30.

Specifically, the second communication unit 12 transmits the local control status packet 74 to the gateway 40. The gateway 40 transfers the local control status packet 74 to the controller 30. Eventually, the controller 30 receives the local control status packet 74 from the gateway 40.

In this manner, when the attribute of the current state of the local state machine 13 is a local control attribute, the execution control unit 14 notifies the local state machine 13 of the input value and the shared internal value, thereby causing the local state machine 13 to generate the output value, the state transition destination, and the updated value of the shared internal value and also causing the local state machine 13 to cause the state to make a transition to the state transition destination. Furthermore, the execution control unit 14 transmits, to the controller 30, the local control status packet 74 for providing notification of the state transition destination and the updated value of the shared internal value generated by the local state machine 13.

### Description of Effects of Embodiment

In the foregoing, according to the present embodiment, the device to be caused to perform the output value generating process can be switched between the remote device (controller 30) and the local device (input/output device 10) for each state in accordance with the state transition.

That is, according to the present embodiment, in the control system 60 based on control specifications that can be defined at the state machine, the process in each state can be distributed to the controller 30 or the input/output device 10 in consideration of required responsiveness. Also, according to the present embodiment, the output value generating process for each state can be controlled in consideration of the order of state transitions and state transition conditions.

As a result, according to the present embodiment, the frequency of error handling such as fail-safe process due to communication error occurring because of communication delay and/or packet loss can be reduced. Thus, availability of the control system 60 can be improved.

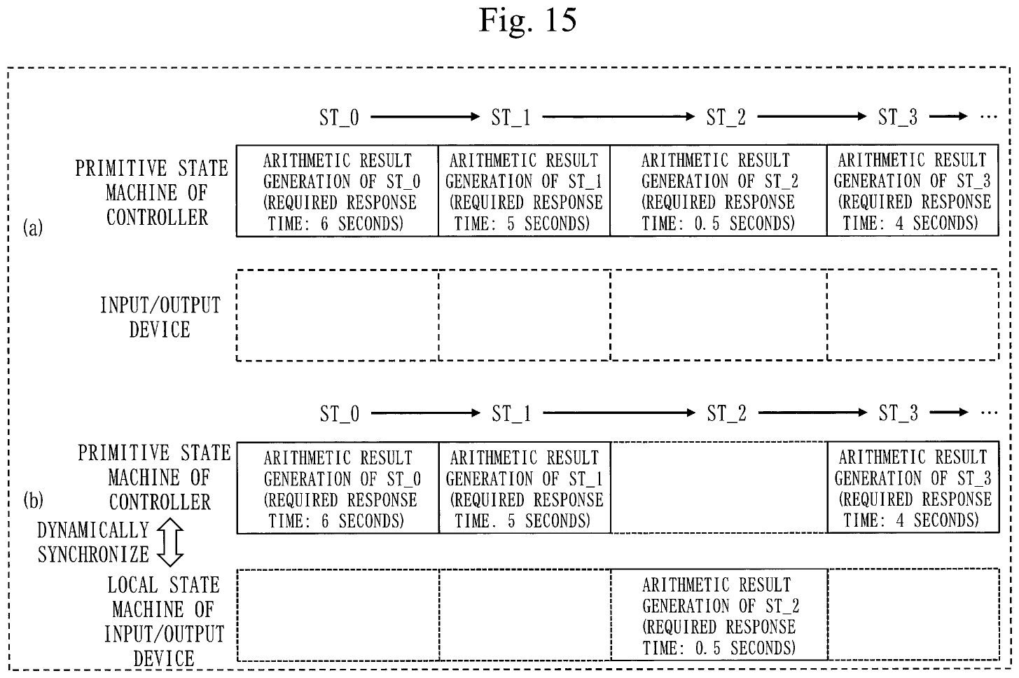

Next, an example of effects obtained by the present embodiment is described by using FIG. 15. Note that “arithmetic result generation” illustrated in FIG. 15 includes generation of an output value, generation of a state transition destination, and generation of an updated value of the shared internal value.

(a) of FIG. 15 illustrates an example of performing an arithmetic result generating process when the control method according to the present embodiment is not used.

In the example of (a) of FIG. 15, it is required to perform the arithmetic result generating process in all states at the primitive state machine 32 of the controller 30.

Here, it is required to set a timeout time in the output process of the input/output device 10 (corresponding to T_err at step S45 of FIG. 13) in consideration of a minimum value of required response time in a state in which the arithmetic result generating process is performed at the primitive state machine 32. Therefore, in the example of (a) of FIG. 15, it is required to set the timeout time in the output process of the input/output device 10 in consideration of 0.5 seconds, which is a required response time of ST_2.

(b) of FIG. 15 illustrates an example of performing the arithmetic result generating process when the control method according to the present embodiment is used.

In the example of (b) of FIG. 15, the arithmetic result generating process of ST_0, ST_1, and ST_3 is performed at the primitive state machine 32 of the controller 30. On the other hand, the arithmetic result generating process of ST_2 with small required response time is performed at the local state machine 13 of the input/output device 10.

As described above, it is required to set a timeout time in the output process of the input/output device 10 (corresponding to T_err at step S45 of FIG. 13) in consideration of a minimum value of required response time in a state in which the arithmetic result generating process is performed at the primitive state machine 32. In the example of (b) of FIG. 15, the timeout time in the output process of the input/output device 10 is only required to be set in consideration of four seconds, which is the required response time of ST_3.

Thus, the timeout time can be set longer in the example of (b) of FIG. 15 than that in the example of (a) of FIG. 15. Therefore, according to the present embodiment, the frequency of error handling such as fail-safe process due to communication error can be reduced. As a result, availability of the control system 60 can be improved.

### Embodiment 2

In the present embodiment, the control system 60 in which a plurality of input/output devices 10 are included is described. And, in the present embodiment, the local state machine 13 of one input/output device 10 generates an output value to the control target device 20 by using the input value acquired by another input/output device 10 from the control target device 20.

In the present embodiment, differences from Embodiment 1 are mainly described.

Note that matters not described below are similar to those of Embodiment 1.

***Description of Structure***

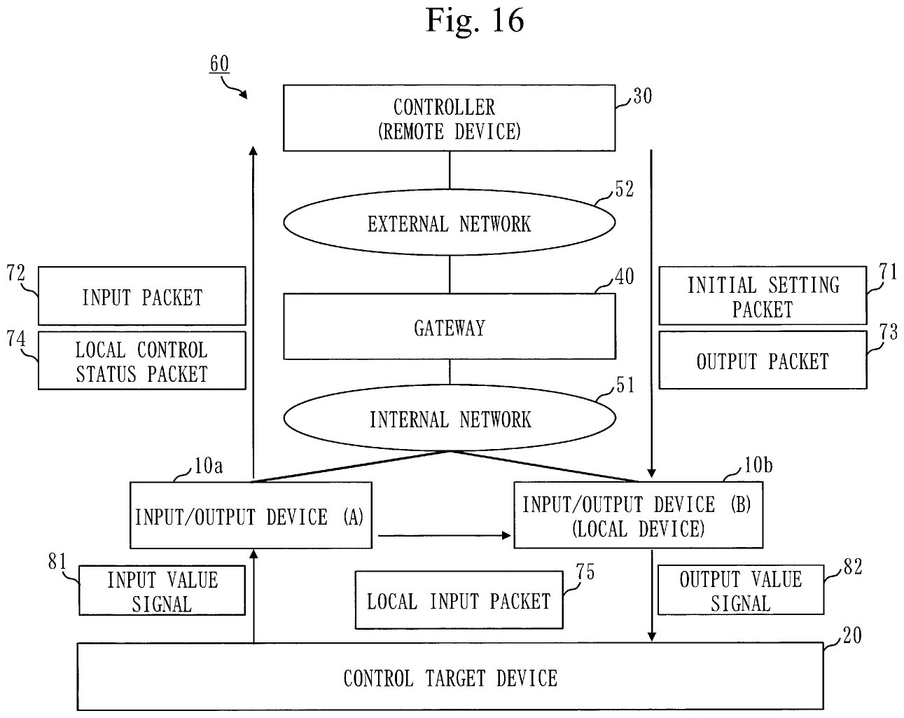

FIG. 16 illustrates an example of structure of the control system 60 according to the present embodiment.

In FIG. 16, two input/output devices 10, that is, an input/output device (A) 10a and an input/output device (B) 10b, are present. And, in the structure of FIG. 16, a local input packet 75 is transmitted from the input/output device (A) 10a to the input/output device (B) 10b. The local input packet 75 is a packet for notifying the input/output device (B) 10b of the input value acquired by the input/output device (A) 10a from the control target device 20.

In the present embodiment, using the input value from the control target device 20 of which notification is provided by the local input packet 75, the local state machine 13 included in the input/output device (B) 10b generates an output value to the control target device 20, specifies a state transition destination, and updates a shared internal value. In the present embodiment, the input/output device (B) 10b corresponds to a local device.

An example of functional structure of the input/output device (A) 10a and the input/output device (B) 10b is identical to the example of functional structure of the input/output device 10 illustrated in FIG. 8. Also, an example of hardware structure of the input/output device (A) 10a and the input/output device (B) 10b is identical to the example of hardware structure of the input/output device 10 illustrated in FIG. 25.

***Description of Operation***

<<Operation at Initializing Process>>

The operation at the initializing process is identical to that of Embodiment 1. Thus, description of the operation at the initializing process is omitted.

<<Operation after Initializing Process>>

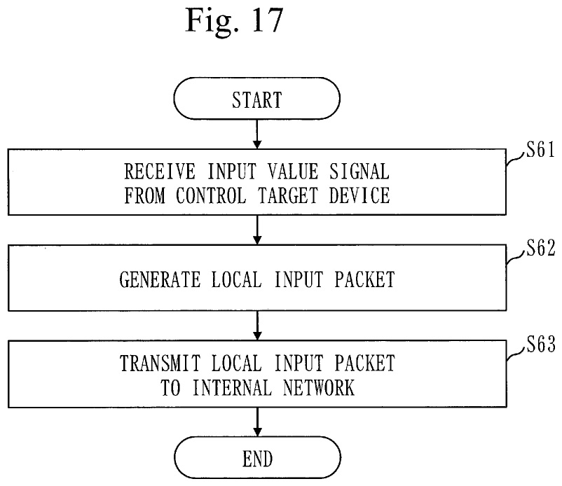

FIG. 17 illustrates an example of a local input process by the input/output device (A) 10a and the input/output device (B) 10b.

In addition to the input process (FIG. 11) illustrated in Embodiment 1, the input/output device (A) 10a also performs the local input process illustrated in FIG. 17.

The flow illustrated in FIG. 17 is assumed to be started for each defined control period T1.

First, at step S61, the first communication unit 11 of the input/output device (A) 10a receives the input value signal 81 from the control target device 20.

The first communication unit 11 of the input/output device (A) 10a outputs the received input value signal 81 to the execution control unit 14 of the input/output device (A) 10a.

Next, at step S62, the execution control unit 14 of the input/output device (A) 10a generates the local input packet 75 by using the input value.

That is, the execution control unit 14 extracts the input value from the input value signal 81, and generates the local input packet 75 by using the extracted input value. Then, the execution control unit 14 outputs the local input packet 75 to the second communication unit 12. The local input packet 75 consists of a header, an input value, and a footer, for example.

Note that the execution control unit 14 of the input/output device (A) 10a retains the input value in the input value buffer (not illustrated), which is an internal buffer), until the next control period T1 arrives and new step S62 is performed.

Next, at step S63, the second communication unit 12 of the input/output device (A) 10a transmits the local input packet 75 to the internal network 51.

Note that the second communication unit 12 of the input/output device (A) 10a may transmit the local input packet 75 in any of unicast, broadcast, and multicast manners.

The input/output device (B) 10b receives the local input packet 75 from the internal network 51.

Note that the example has been described above in which the flow of FIG. 17 is started for each control period T1. Other than arrival of the control period T1, the flow of FIG. 17 may be started at either of timings below.
1) When the attributes of the current state of the primitive state machine 32 of the controller 30 and the current state of the local state machine 13 of the input/output device (B) 10b are local control attributes

In this example, the execution control unit 14 of the input/output device (A) 10a is assumed to recognize the attribute of the current state of the primitive state machine 32 of the controller 30 or the local state machine 13 of the input/output device (B) 10b. And, when the execution control unit 14 of the input/output device (A) 10a recognizes that the attribute of the current state of the primitive state machine 32 of the controller 30 or the local state machine 13 of the input/output device (B) 10b is a local control attribute, the flow of FIG. 17 starts.
2) When the input/output device (A) 10a receives a request for transmission of the local input packet 75 from the input/output device (B) 10b

In this case, the execution control unit 14 of the input/output device (B) 10b generates a request for transmission of the local input packet 75, and the second communication unit 12 of the input/output device (B) 10b transmits the request for transmission to the input/output device (A) 10a. Then, the first communication unit 11 of the input/output device (A) 10a receives the request for transmission, and when the execution control unit 14 recognizes that the first communication unit 11 has received the request for transmission, the flow of FIG. 17 starts.

To allow the flow of FIG. 17 to start at any of the above-described timings of 1) and 2), a step may be added to the flow of FIG. 17.

In the present embodiment, an example of operation of the controller 30 is identical to that of Embodiment 1 (FIG. 12). Thus, description of the example of operation of the controller 30 according to the present embodiment is omitted.

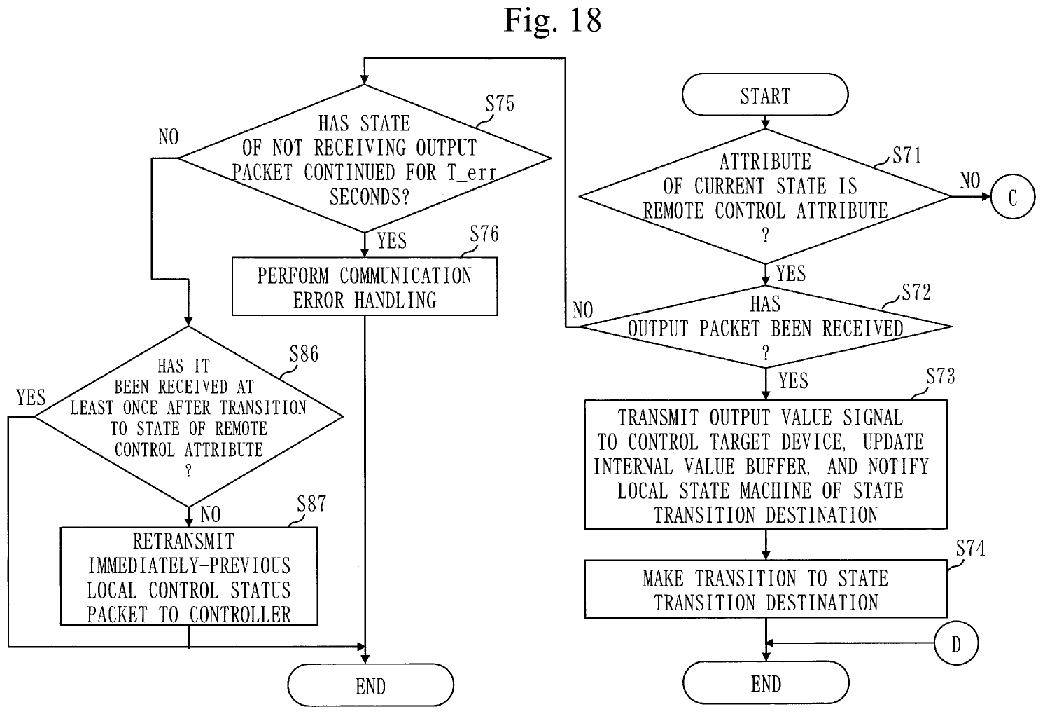

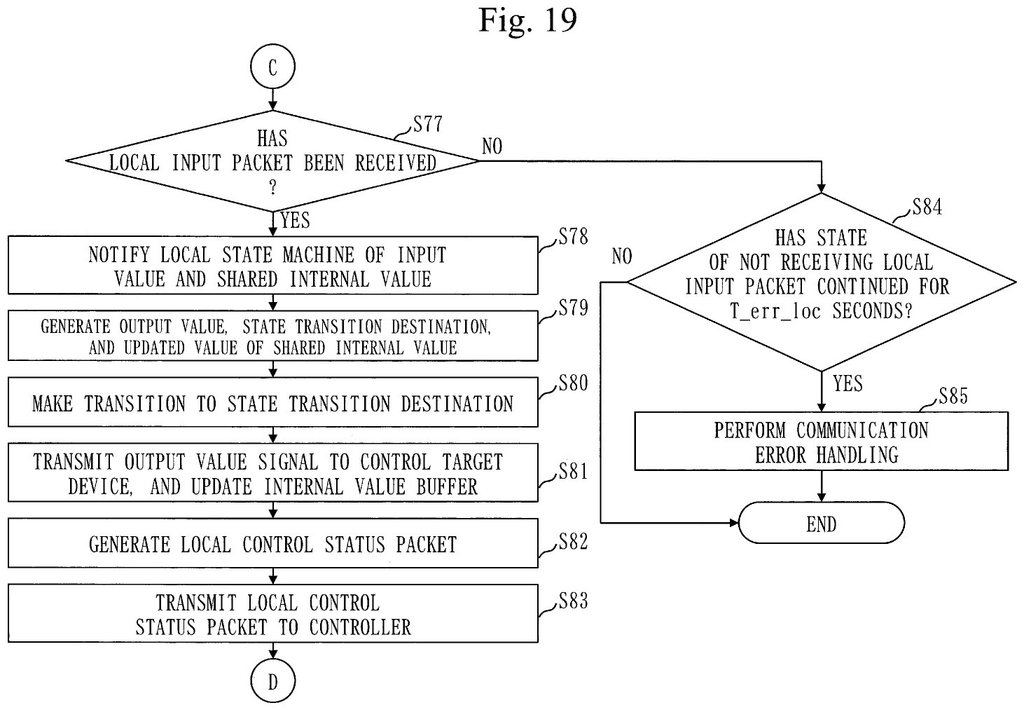

FIG. 18 and FIG. 19 illustrate an example of operation of the input/output device (B) 10b.

Step S71 to step S76, step S86, and step S87 of FIG. 18 are identical to step S41 to step S46, step S53, and step S54 of FIG. 13. Thus, description of step S71 to step S76, step S86, and step S87 is omitted.

In FIG. 19, at step S77, the execution control unit 14 of the input/output device (B) 10b determines whether the local input packet 75 has been received from the input/output device (A) 10a.

If the local input packet 75 has been received from the input/output device (A) 10a, the process proceeds to step S78. On the other hand, if the local input packet 75 has not been received from the input/output device (A) 10a, the process proceeds to step S84.

At step S78, the execution control unit 14 of the input/output device (B) 10b notifies the local state machine 13 of the input value from the control target device 20 and the shared internal value.

That is, the execution control unit 14 notifies the local state machine 13 of the input value included in the local input packet 75 received from the input/output device (A) 10a at step S61 of FIG. 17 and the shared internal value retained in the internal value buffer 15.

Step S79 to step S83 are identical to step S48 to step S52 of FIG. 14. Thus, description of step S79 to step S83 is omitted.

When it is determined at step S77 that the local input packet 75 has not been received, at step S84, the execution control unit 14 of the input/output device (B) 10b determines whether a state of not receiving the local input packet 75 has continued for T_err_loc seconds.

If the state of not receiving the local input packet 75 has continued for T_err_loc seconds, the process proceeds to step S85. On the other hand, if the state of not receiving the local input packet 75 has continued for less than T_err_loc seconds, the process ends.

At step S85, the execution control unit 14 of the input/output device (B) 10b performs defined communication error handling. The communication error handling is, for example, a fail-safe process such as emergency stop.

Note that, as described in Embodiment 1, the internal network 51 is a communication path in which only an assumed traffic is present and prediction of worst values of communication delay and jitter is easy. Thus, the possibility that the process proceeds from step S77 to step S84 in FIG. 19 is assumed to be extremely small.

### ***Description of Effects of Embodiment***

According to the present embodiment, even if the plurality of input/output devices 10 are present, effects similar to those of Embodiment 1 can be acquired. That is, even if the local state machine 13 of one input/output device 10 generates an output value to the control target device 20 by using the input value acquired by another input/output device 10 from the control target device 20, effects similar to those of Embodiment 1 can be acquired.

### Embodiment 3

In the present embodiment, an example is described in which not the input/output device 10 but the gateway 40 functions as a local device.

In Embodiment 1 and Embodiment 2, the input/output device 10 has the local state machine 13 and the execution control unit 14, and the input/output device 10 functions as a local device. However, due to compatibility with a conventional device or a problem in cost, a situation can be also assumed in which implementing the local state machine 13 and the execution control unit 14 on the input/output device 10 is difficult.

In the present embodiment, to address this situation, structures similar to the local state machine 13 and the execution control unit 14 described in Embodiment 1 and Embodiment 2 are arranged on the gateway 40, and the gateway 40 is caused to function as a local device.

In the present embodiment, differences from Embodiment 1 are mainly described.

Note that matters not described below are similar to those of Embodiment 1.

***Description of Structure***

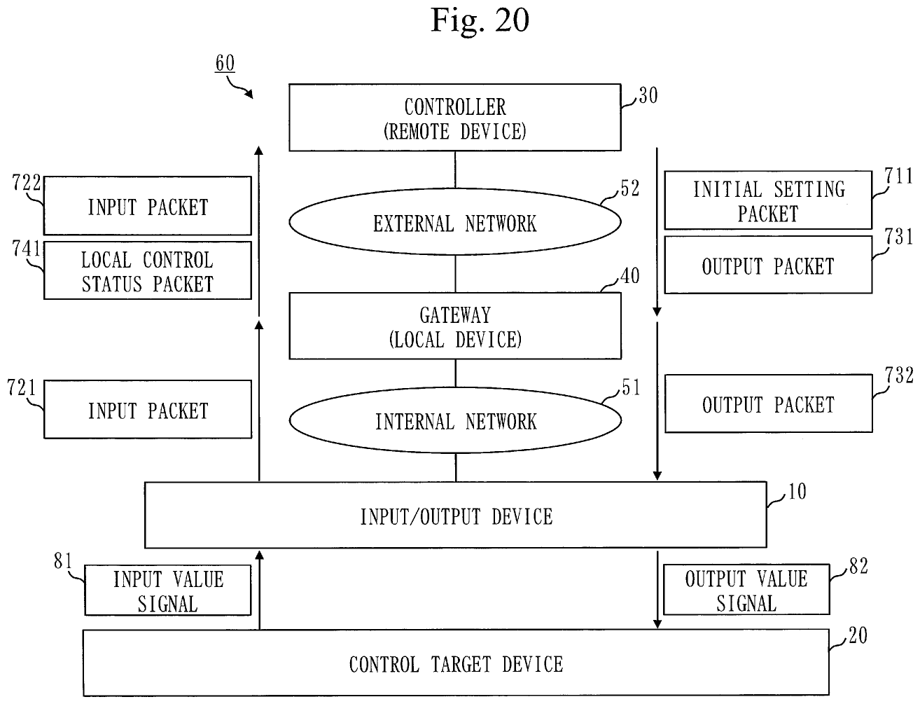

FIG. 20 illustrates an example of structure of the control system 60 according to the present embodiment.

In the present embodiment, not the input/output device 10 but the gateway 40 corresponds to a local device.

Also, in the present embodiment, the input/output device 10 transmits an input packet 721 to the gateway 40.

The gateway 40 receives the input packet 721, and transmits an input packet 722 and a local control status packet 741 to the controller 30.

The input packet 721 and the input packet 722 are identical to the input packet 72 illustrated in FIG. 1, except an address included in the header. In the input packet 72, the destination address is the address of the controller 30, and the transmission source address is the address of the input/output device 10. In the input packet 721, the destination address is the address of the gateway 40, and the transmission source address is the address of the input/output device 10. In the input packet 722, the destination address is the address of the controller 30, and the transmission source address is the address of the gateway 40.

Also, the local control status packet 741 is identical to the local control status packet 74 illustrated in FIG. 1, except an address included in the header. In the local control status packet 74, the destination address is the address of the controller 30, and the transmission source address is the address of the input/output device 10. In the local control status packet 741, the destination address is the address of the controller 30, and the transmission source address is the address of the gateway 40.

Also, in the present embodiment, the controller 30 transmits an initial setting packet 711 and an output packet 731 to the gateway 40.

The gateway 40 receives the initial setting packet 711 and the output packet 731, and transmits an output packet 732 to the input/output device 10.

The initial setting packet 711 is identical to the initial setting packet 71 illustrated in FIG. 1, except an address included in the header. In the initial setting packet 71, the destination address is of the input/output device 10, and the transmission source address is of the controller 30. In the initial setting packet 711, the destination address is of the gateway 40, and the transmission source address is of the controller 30.

The output packet 731 and the output packet 732 are identical to the output packet 73 illustrated in FIG. 1, except an address included in the header. In the output packet 73, the destination address is of the input/output device 10, and the transmission source address is of the controller 30. In the output packet 731, the destination address is of the gateway 40, and the transmission source address is of the controller 30. In the output packet 732, the destination address is of the input/output device 10, and the transmission source address is of the gateway 40.

In the output packet 731, as with the output packet 73, the output value, the state transition destination, and the updated value of the shared internal value are included. In the output packet 732, only the output value may be included, and the state transition destination and the updated value of the shared internal value may not be included. This is because, in the present embodiment, the input/output device 10 does not use the state transition destination and the updated value of the shared internal value.

The other components illustrated in FIG. 20 are identical to the corresponding components of FIG. 1.

Illustration of an example of functional structure of the input/output device 10 according to the present embodiment is omitted. In the present embodiment, as an example of functional structure of the input/output device 10, it can be thought that the structure is such that, from the structure illustrated in FIG. 8, the local state machine 13, the execution control unit 14, the internal value buffer 15, and the state attribute table 16 are removed.

The functional structure of the controller 30 is identical to that illustrated in FIG. 9. Thus, description is omitted.

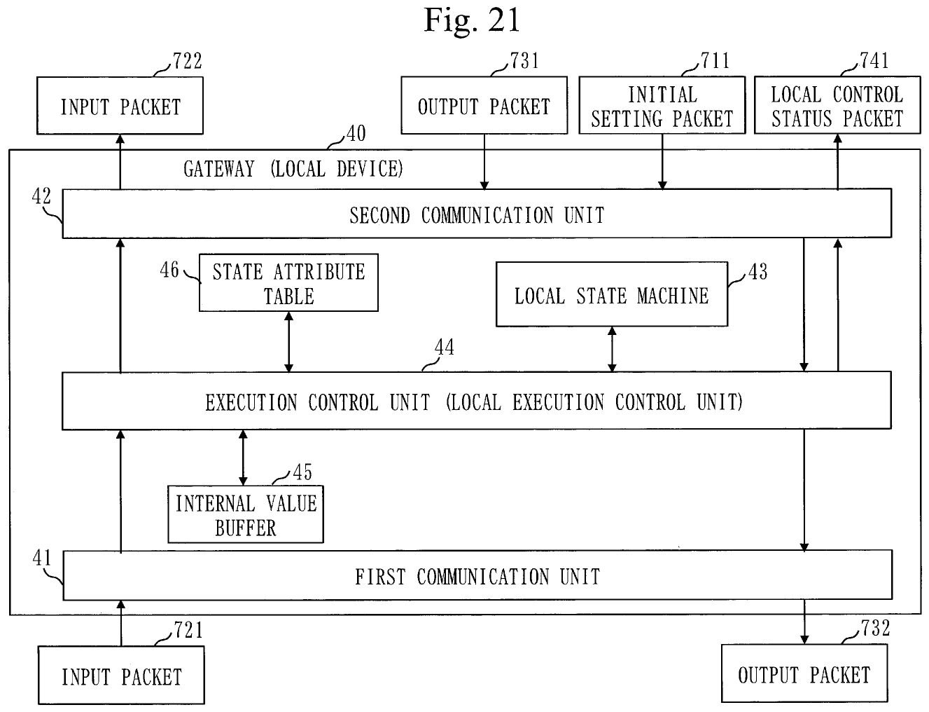

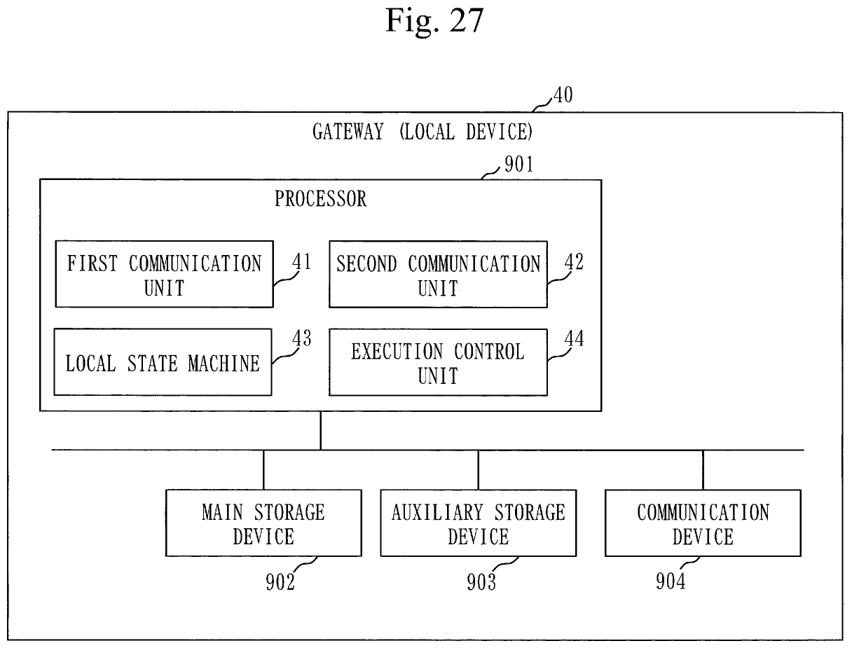

FIG. 21 illustrates an example of functional structure of the gateway 40 according to the present embodiment. FIG. 27 illustrates an example of hardware structure of the gateway 40 according to the present embodiment.

First, with reference to FIG. 27, the example of hardware structure of the gateway 40 is described.

The gateway 40 according to the present embodiment is a computer.

The gateway 40 includes, as hardware, a processor 901, a main storage device 902, an auxiliary storage device 903, and a communication device 904.

In the auxiliary storage device 903, programs realizing the functions of a first communication unit 41, a second communication unit 42, a local state machine 43, and an execution control unit 44, which will be described further below with reference to FIG. 21, are stored.

These programs are loaded from the auxiliary storage device 903 to the main storage device 902. Then, the processor 901 executes these programs to perform operations of the first communication unit 41, the second communication unit 42, the local state machine 43, and the execution control unit 44, which will be described further below.

In FIG. 27, a state is schematically illustrated in which the processor 901 is executing the programs realizing the functions of the first communication unit 41, the second communication unit 42, the local state machine 43, and the execution control unit 44.

Next, with reference to FIG. 21, the example of functional structure of the gateway 40 is described.

The first communication unit 41 communicates with the input/output device 10.

Specifically, by using the communication device 904, the first communication unit 41 receives the input packet 721 from the input/output device 10. Also, by using the communication device 904, the first communication unit 41 transmits the output packet 732 to the input/output device 10.

The second communication unit 42 communicates with the controller 30.

Specifically, by using the communication device 904, the second communication unit 42 transmits the input packet 722 and the local control status packet 741 to the controller 30. Also, by using the communication device 904, the second communication unit 42 receives the initial setting packet 711 and the output packet 731 from the controller 30.

The local state machine 43 is the local state machine described by using FIG. 2.

When the attribute of the current state of the state machine (local state machine 43) is a remote control attribute, the execution control unit 44 causes the remote device (controller 30) in a remote environment for the control target device 20 to execute the output value generating process of generating an output value to the control target device 20. On the other hand, when the attribute of the current state of the state machine (local state machine 43) is a local control attribute, the execution control unit 44 causes the local device (gateway 40) in a local environment for the control target device 20 to execute the output value generating process.

The execution control unit 44 corresponds to a local execution control unit.

Also, in the present embodiment, the process to be performed by the execution control unit 44 and the execution control unit 33 of the controller 30 corresponds to an execution control process.

Since the operation of the execution control unit 44 is basically identical to the operation of the execution control unit 14 described in Embodiment 1, detailed description is omitted.

An internal value buffer 45 is a buffer which retains internal values including the shared internal value. Note that w % ben no internal value is required for control of the control target device 20, the internal value buffer 45 may be omitted.

A state attribute table 46 is the state attribute table illustrated in FIG. 7. The state attribute table 46 is identical to the state attribute table 16.

***Description of Operation***

<<Operation at Initializing Process>>

In the present embodiment, the controller 30 and the gateway 40 perform operation illustrated in FIG. 10.

Step S11 to step S13 are operation of the controller 30. Step S11 to step S13 are identical to those described in Embodiment 1, except that packets to be transmitted and received and the transmission destination of the packet are different. That is, in the present embodiment, not the initial setting packet 71 but the initial setting packet 711 is transmitted to not the input/output device 10 but the gateway 40.

At step S14, the execution control unit 44 enables the state attribute table 35 included in the initial setting packet 711 to be referred to as the state attribute table 46, and sets the local state machine program included in the initial setting packet 711 to the local state machine 43.

That is, the second communication unit 42 receives the initial setting packet 711, and outputs the initial setting packet 711 to the execution control unit 44. The execution control unit 44 extracts the state attribute table 35 from the initial setting packet 711, implements the extracted state attribute table 35 in the main storage device 902, and enables it to be referred to as the state attribute table 46. Also, the execution control unit 44 extracts the local state machine program from the initial setting packet 711, implements the extracted local state machine program in the main storage device 902, enables the local state machine 43 to execute the local state machine program.

<<Operation after Initializing Process>>

Next, the operation after the initializing process is described.

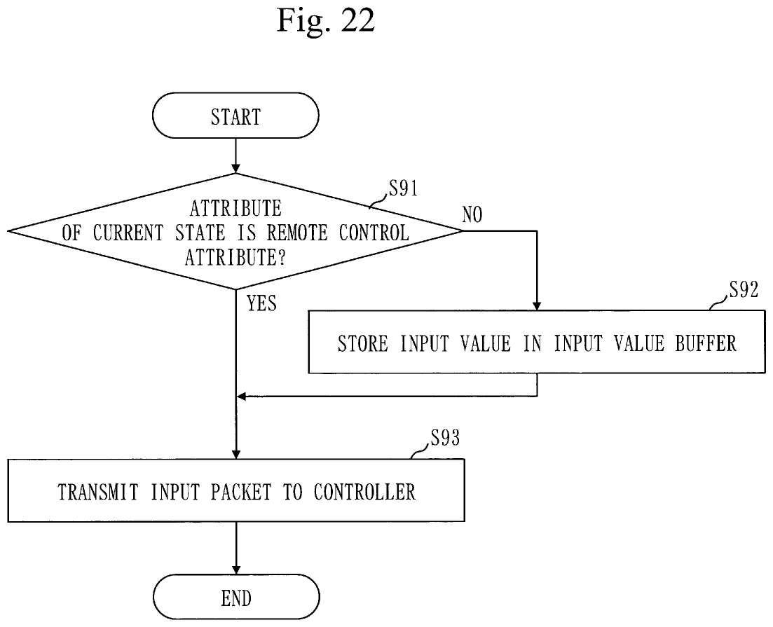

FIG. 22 illustrates an example of an input process by the gateway 40.

By using FIG. 22, the input process is described.

The flow illustrated in FIG. 22 is assumed to be started for each reception of the input packet 721.

First, at step S91, the execution control unit 44 determines whether the attribute of the current state of the local state machine 43 is a remote control attribute.

More specifically, the execution control unit 44 refers to the state attribute table 46 to determine whether the attribute of the current state of the local state machine 43 is a remote control attribute. The execution control unit 44 has a state buffer (not illustrated), which is an internal buffer for recording the current state of the local state machine 43. Whenever a state transition occurs at the local state machine 43, the execution control unit 44 records the state of the state transition destination in the state buffer as the current state of the local state machine 43. At step 591, the execution control unit 44 determines the attribute of the current state recorded in the state buffer by referring to the state attribute table 46. For example, when the state stored in the state buffer is ST_1, the execution control unit 44 can determine from the state attribute table 46 that the attribute of the current state of the local state machine 43 is a remote control attribute.

When the attribute of the current state of the local state machine 43 is a local control attribute, the process proceeds to step S92. On the other hand, when the attribute of the current state of the local state machine 43 is a remote control attribute, the process proceeds to step S93.

At step S92, the execution control unit 44 causes the input value to be stored in the input value buffer, which is an internal buffer.

That is, the execution control unit 44 extracts the input value from the input packet 721 received by the first communication unit 41 from the input/output device 10, and causes the extracted input value to be stored in the input value buffer. The input value buffer and the state buffer may be the same internal buffer or may be different internal buffers.

At step S93, the execution control unit 44 transmits the input packet 722 to the controller 30.

That is, the execution control unit 44 generates the input packet 722 for providing notification of the input value included in the input packet 721, and outputs the generated input packet 722 to the second communication unit 42. Then, the second communication unit 42 transmits the input packet 722 to the controller 30. The controller 30 receives the input packet 722.

In the present embodiment, an example of operation of the controller 30 is identical to that of Embodiment 1 (FIG. 12). Thus, description of the example of operation of the controller 30 according to the present embodiment is omitted.

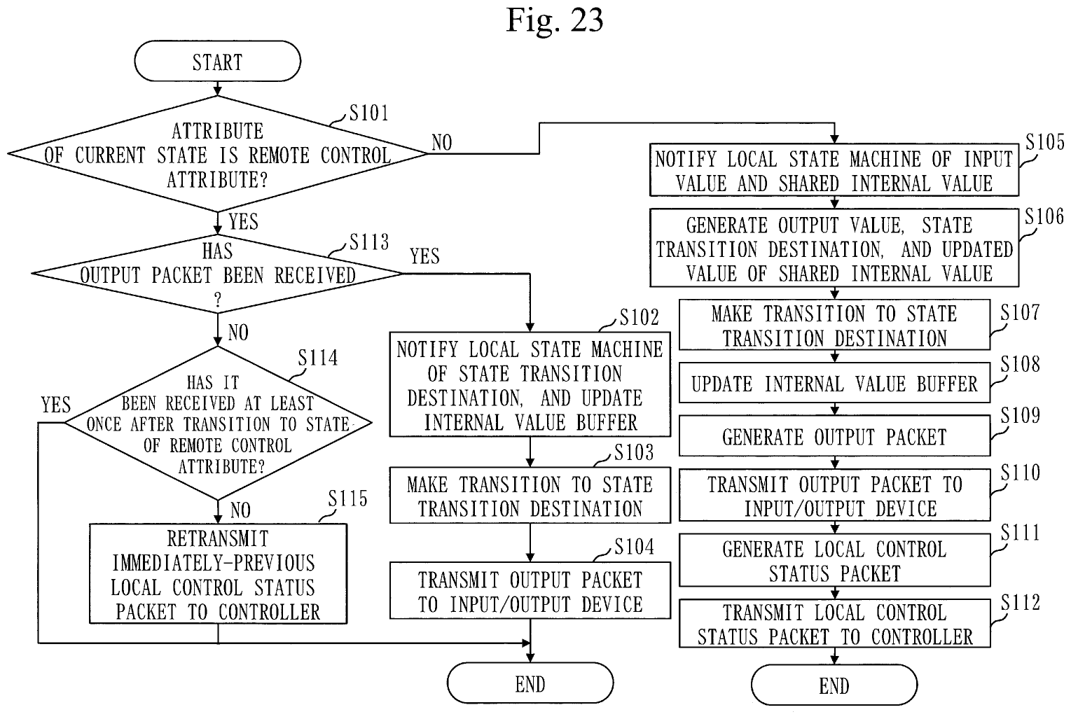

FIG. 23 illustrates an example of operation of the gateway 40 according to the present embodiment.

The flow of FIG. 23 is assumed to be started for each control period T1 or at reception of the output packet 731.

First, at step S101, the execution control unit 44 determines whether the attribute of the current state of the local state machine 43 is a remote control attribute.

More specifically, the execution control unit 44 refers to the state attribute table 46 to determine whether the attribute of the current state of the local state machine 43 is a remote control attribute. The execution control unit 44 has a state buffer (not illustrated), which is an internal buffer for recording the current state of the local state machine 43. Whenever a state transition occurs at the local state machine 43, the execution control unit 44 records the state of the state transition destination in the state buffer as the current state of the local state machine 43. At step S101, the execution control unit 44 determines the attribute of the current state recorded in the state buffer by referring to the state attribute table 46. For example, when the state stored in the state buffer is ST_1, the execution control unit 44 can determine from the state attribute table 46 that the attribute of the current state of the local state machine 43 is a remote control attribute.

When the attribute of the current state of the local state machine 43 is a remote control attribute, the process proceeds to step S113. On the other hand, when the attribute of the current state of the local state machine 43 is a local control attribute, the process proceeds to step S105.

At step S113, the execution control unit 44 determines whether the output packet 731 has been received. If the output packet 731 has been received, the process proceeds to step S102. On the other hand, if the output packet 731 has not been received, the process proceeds to step S114.

At step S102, the execution control unit 44 notifies the local state machine 43 of the state transition destination, and updates the internal value buffer 45.

That is, the execution control unit 44 notifies the local state machine 43 of the state transition destination included in the output packet 731.

Furthermore, the execution control unit 44 updates the internal value buffer 45 by using the updated value of the shared internal value included in the output packet 731.

Next, at step S103, the local state machine 43 causes the state to make a transition to the state transition destination of which notification is provided from the execution control unit 44.

Next, at step S104, the execution control unit 44 transmits the output packet 732 via the first communication unit 41 to the input/output device 10.

That is, the execution control unit 44 generates the output packet 732 for providing notification of the output value included in the output packet 731. Then, the execution control unit 44 outputs the generated output packet 732 to the first communication unit 41. The first communication unit 41 transmits the output packet 732 to the input/output device 10. Note that, as described above, the state transition destination and the updated value of the shared internal value may not be included in the output packet 732.

In this manner, when the attribute of the current state of the local state machine 43 is a remote control attribute, the execution control unit 44 notifies the local state machine 43 of the state transition destination decided at the controller 30, thereby causing the local state machine 43 to cause the state to make a transition to the state transition destination decided at the controller 30. Furthermore, the execution control unit 44 updates the internal value buffer 45 by using the updated value of the shared internal value decided at the controller 30. Also, the execution control unit 44 notifies the control target device 20 of the output value decided at the controller 30.

When it is determined at step S101 that the attribute of the current state of the local state machine 43 is a local control attribute, at step S105, the execution control unit 44 notifies the local state machine 43 of the input value from the control target device 20 and the shared internal value.

That is, the execution control unit 44 notifies the local state machine 43 of the input value included in the input packet 721 received by the first communication unit 41 from the input/output device 10 and the shared internal value retained in the internal value buffer 45.

At step S106, the local state machine 43 executes arithmetic means corresponding to the current state to generate an output value, a state transition destination, and an updated value of the shared internal value by using the input value of which notification is provided from the execution control unit 44 and the shared internal value.

Also, the local state machine 43 notifies the execution control unit 44 of the output value, the state transition destination, and the updated value of the shared internal value.

Next, at step S107, the local state machine 43 causes the state to make a transition to the state transition destination generated at step S106.

Next, at step S108, the execution control unit 44 updates the internal value buffer 45.

That is, the execution control unit 44 updates the internal value buffer 45 by using the updated value of the shared internal value generated by the local state machine 43 at step S106.

Also, the execution control unit 44 updates the current state of the state buffer to the state of the state transition destination.

Next, at step S109, the execution control unit 44 generates the output packet 732.

That is, the execution control unit 44 generates the output packet 732 for providing notification of the output value generated by the local state machine 43 at step S106. Note that, as described above, the state transition destination and the updated value of the shared internal value may not be included in the output packet 732.

Then, the execution control unit 44 outputs the output packet 732 to the first communication unit 41.

Next, at step S110, the first communication unit 41 transmits the output packet 732 to the input/output device 10.

Next, at step S11l, the execution control unit 44 generates the local control status packet 741.

That is, a packet for providing notification of the state transition destination and the updated value of the shared internal value generated by the local state machine 43 at step S106 is generated as the local control status packet 741. Then, the local control status packet 741 is outputted to the second communication unit 42.

Next, at step S112, the second communication unit 42 transmits the local control status packet 741 to the controller 30.

When it is determined at step S113 that the output packet 731 has not been received, at step S114, the execution control unit 44 determines whether the output packet 731 has been received at least once after a transition is made from the state of the local control attribute to the state of the remote control attribute. If the output packet 731 has not been received once, the process proceeds to step S115. If the output packet 731 has been received at least once, the process ends.

At step S115, the execution control unit 44 again transmits the local control status packet 741 generated in the state of the immediately-previous local control attribute to the controller 30. Note that the local control status packet 741 is assumed to have been buffered for this process. After step S115, the process ends.

In this manner, when the attribute of the current state of the local state machine 43 is a local control attribute, the execution control unit 44 notifies the local state machine 43 of the input value, thereby causing the local state machine 43 to generate the output value, the state transition destination, and the updated value of the shared internal value and also causing the local state machine 43 to cause the state to make a transition to the state transition destination. Furthermore, the execution control unit 44 transmits, to the controller 30, the local control status packet 741 for providing notification of the state transition destination and the updated value of the shared internal value generated by the local state machine 43. Also, the execution control unit 44 transmits, to the input/output device 10, the output packet 732 for providing notification of the output value generated by the local state machine 43.

### Description of Effects of Embodiment

In the present embodiment, the gateway 40 has the local state machine 43 and the execution control unit 44, and functions as a local device. Thus, according to the present embodiment, even if the local state machine 13 and the execution control unit 14 are not implemented on the input/output device 10, effects similar to those of Embodiment 1 can be acquired.

### Embodiment 4

In Embodiments 1 to 3, the number of states to which the execution control unit 33 sets a local control attribute is a fixed number (L). In the present embodiment, an example is described in which the execution control unit 33 dynamically decides, based on communication quality, the number of states to which a local control attribute is set.

In the present embodiment, differences from Embodiment 1 are mainly described.

Note that matters not described below are similar to those of Embodiment 1.

***Description of Structure***

In the present embodiment, the structure of the control system 60 is as illustrated in FIG. 1.

Also, the functional structure of the input/output device 10 is as illustrated in FIG. 8, and the hardware structure of the input/output device 10 is also as illustrated in FIG. 25.

Also, the functional structure of the controller 30 is as illustrated in FIG. 9, and the hardware structure of the controller 30 is also as illustrated in FIG. 26.

Note that, in the present embodiment, the execution control unit 33 decides, based on communication quality of a communication line for use when the controller 30 communicates with the input/output device 10, the number of states to which a local control attribute is set. More specifically, in the present embodiment, of the plurality of states, the execution control unit 33 sets an attribute of a state in which the required response time is predicted not to be satisfied as a local control attribute. Then, the execution control unit 33 sets the attributes of the remaining states of the plurality of states as a remote control attribute.

***Description of Operation***

<<Operation at Initializing Process>>

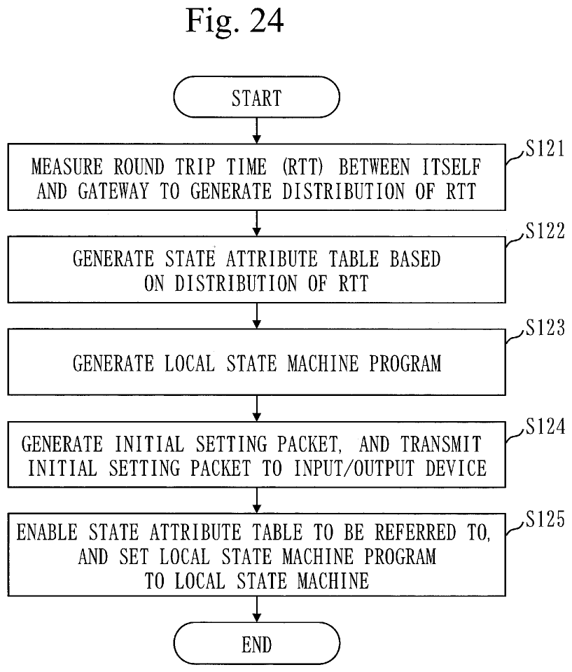

FIG. 24 illustrates an initializing process according to the present embodiment.

At step S121, the execution control unit 33 measures RTT (Round Trip Time) between itself and the gateway 40 to generate a distribution of RTT.

That is, the execution control unit 33 measures RTT, which represents communication quality of the external network 52, which is a communication line for use when communicating with the input/output device 10. Then, the execution control unit 33 generates a distribution of measured RT. Note that when RTT information measured before execution of step S121 can be used in addition to measurement information of RTT measured at step S121, a distribution of RTT may be generated also by including this.

Next, at step S122, the execution control unit 33 generates the state attribute table 35 based on the distribution of RTT generated at step S121.

Specifically, the execution control unit 33 calculates, based on the distribution of RTT generated at step S121, a probability pp satisfying the required response time for each state included in the primitive state machine 32. Then, the execution control unit 33 sets a state with the probability pp being less than a required probability P as a local control attribute. Also, the execution control unit 33 sets a state with the probability pp being equal to or more than the required probability P as a remote control attribute. The required probability P is a minimum value required for the probability pp. When the probability pp is equal to or more than the required probability P, the execution control unit 33 predicts that the probability pp satisfies the required response time. That is, the execution control unit 33 sets the attribute of a state in which the required response time is predicted not to be satisfied as a local control attribute, and sets the attribute of a state in which the required response time is predicted to be satisfied as a remote control attribute.

Since step S123 to step S125 are identical to step S12 to step S14 illustrated in FIG. 10, description is omitted.

Note that while the distribution of RTT is used herein as an index for communication quality of the external network 52, another index may be used as an index for communication quality.

Since the operation after the initializing process is identical to that of Embodiment 1, description is omitted.

### Description of Effects of Embodiment

In the present embodiment, the state in which the required response time is predicted not to be satisfied is set as a local control attribute. Thus, according to the present embodiment, while the number of states to which a local control attribute is set is decided based on communication quality, effects similar to those of Embodiment 1 can be acquired.

While Embodiments 1 to 4 have been described above, of these embodiments, two or more may be combined for execution.

Alternatively, of these embodiments, one may be partially implemented.

Alternatively, of these embodiments, two or more may be partially combined for execution.

Also, the structures and procedures described in these embodiments may be changed as required.

***Supplemental Description of Hardware Structure***

Lastly, supplemental description of hardware structure of the input/output device 10, the controller 30, and the gateway 40 is performed.

The processor 701, the processor 801, and the processor 901 are each an IC (Integrated Circuit) for performing processing.

The processor 701, the processor 801, and the processor 901 are each a CPU (Central Processing Unit), DSP (Digital Signal Processor), or the like.

The main storage device 702, the main storage device 802, and the main storage device 902 are each a RAM (Random Access Memory).

The auxiliary storage device 703, the auxiliary storage device 803, and the auxiliary storage device 903 are each a ROM (Read Only Memory), flash memory, HDD (Hard Disk Drive), or the like.

The communication device 704, the communication device 804, and the communication device 904 are each an electronic circuit which performs data communication process.

The communication device 704, the communication device 804, and the communication device 904 are, for example, each a communication chip or NIC (Network Interface Card).

Also, in the auxiliary storage device 703, an OS (Operating System) is stored.

And, at least part of the OS is executed by the processor 701.

While executing at least part of the OS, the processor 701 executes programs realizing the functions of the first communication unit 11, the second communication unit 12, the local state machine 13, and the execution control unit 14.

With the processor 701 executing the OS, task management, memory management, file management, communication control, and so forth are performed.

Also, in the auxiliary storage device 803, an OS is also stored.

And, at least part of the OS is executed by the processor 801.

While executing at least part of the OS, the processor 801 executes programs realizing the functions of the communication unit 31, the primitive state machine 32, and the execution control unit 33.

With the processor 801 executing the OS, task management, memory management, file management, communication control, and so forth are performed.

Also, in the auxiliary storage device 903, an OS is also stored.

And, at least part of the OS is executed by the processor 901.

While executing at least part of the OS, the processor 901 executes programs realizing the functions of the first communication unit 41, the second communication unit 42, the local state machine 43, and the execution control unit 44.

With the processor 901 executing the OS, task management, memory management, file management, communication control, and so forth are performed.

Also, at least any of information, data, signal values, and variable values indicating the results of processes of the first communication unit 11, the second communication unit 12, the local state machine 13, and the execution control unit 14 is stored in at least any of the main storage device 702, the auxiliary storage device 703, and a register and a cache memory in the processor 701.

Also, programs realizing the functions of the first communication unit 11, the second communication unit 12, the local state machine 13, and the execution control unit 14 may be stored in a portable recording medium such as a magnetic disc, flexible disc, optical disc, compact disc, Blu-ray (registered trademark) disc, or DVD. And, the portable recording medium having stored therein the programs realizing the functions of the first communication unit 11, the second communication unit 12, the local state machine 13, and the execution control unit 14 may be distributed.

Also, “unit” of the first communication unit 11, the second communication unit 12, and the execution control unit 14 may be read as “circuit”, “step”, “procedure”, “process”, or “circuitry”.

Also, the input/output device 10 may be realized by a processing circuit. The processing circuit is, for example, a logic IC (Integrated Circuit), GA (Gate Array), ASIC (Application Specific Integrated Circuit), or FPGA (Field-Programmable Gate Array).

In this case, the first communication unit 11, the second communication unit 12, the local state machine 13, and the execution control unit 14 are each realized as part of the processing circuit.

Also, at least any of information, data, signal values, and variable values indicating the results of processes of the communication unit 31, the primitive state machine 32, and the execution control unit 33 is stored in at least any of the main storage device 802, the auxiliary storage device 803, and a register and a cache memory in the processor 801.

Also, programs realizing the functions of the communication unit 31, the primitive state machine 32, and the execution control unit 33 may be stored in a portable recording medium such as a magnetic disc, flexible disc, optical disc, compact disc, Blu-ray (registered trademark) disc, or DVD. And, the portable recording medium having stored therein the programs realizing the functions of the communication unit 31, the primitive state machine 32, and the execution control unit 33 may be distributed.

Also, “unit” of the communication unit 31 and the execution control unit 33 may be read as “circuit”, “step”, “procedure”, “process”, or “circuitry”.

Also, the controller 30 may be realized by a processing circuit. The processing circuit is, as described above, a logic IC, GA, ASIC, or FPGA, for example.

In this case, the communication unit 31, the primitive state machine 32, and the execution control unit 33 are each realized as part of the processing circuit.

Also, at least any of information, data, signal values, and variable values indicating the results of processes of the first communication unit 41, the second communication unit 42, the local state machine 43, and the execution control unit 44 is stored in at least any of the main storage device 902, the auxiliary storage device 903, and a register and a cache memory in the processor 901.

Also, programs realizing the functions of the first communication unit 41, the second communication unit 42, the local state machine 43, and the execution control unit 44 may be stored in a portable recording medium such as a magnetic disc, flexible disc, optical disc, compact disc, Blu-ray (registered trademark) disc, or DVD. And, the portable recording medium having stored therein the programs realizing the functions of the first communication unit 41, the second communication unit 42, the local state machine 43, and the execution control unit 44 may be distributed.

Also, “unit” of the first communication unit 41, the second communication unit 42, and the execution control unit 44 may be read as “circuit”, “step”, “procedure”, “process”, or “circuitry”.

Also, the gateway 40 may be realized by a processing circuit. The processing circuit is, as described above, a logic IC, GA, ASIC, or FPGA, for example.

In this case, the first communication unit 41, the second communication unit 42, the local state machine 43, and the execution control unit 44 are each realized as part of the processing circuit.

Note that in the present specification, the superordinate concept of the processor and the processing circuit is referred to as “processing circuitry”.

That is, the processor and the processing circuit are each a specific example of “processing circuitry”.

### REFERENCE SIGNS LIST

10: input/output device; 10a: input/output device (A); 10b: input/output device (B); 11: first communication unit; 12: second communication unit; 13: local state machine; 14: execution control unit; 15: internal value buffer; 16: state attribute table; 20: control target device; 30: controller; 31: communication unit; 32: primitive state machine; 33: execution control unit; 34: internal value buffer; 35: state attribute table; 40: gateway; 41: first communication unit; 42: second communication unit; 43: local state machine; 44: execution control unit; 45: internal value buffer; 46: state attribute table; 51: internal network; 52: external network; 60: control system; 71: initial setting packet; 72: input packet; 73: output packet; 74: local control status packet; 75: local input packet; 81: input value signal; 82: output value signal; 701: processor; 702: main storage device; 703: auxiliary storage device; 704: communication device; 711: initial setting packet; 721: input packet; 722: input packet; 731: output packet; 732: output packet; 741: local control status packet; 801: processor; 802: main storage device; 803: auxiliary storage device; 804: communication device; 821: output value signal; 822: output value signal; 901: processor; 902: main storage device; 903: auxiliary storage device; 904: communication device.

1. A control system comprising:
a state machine to make a state transition among a plurality of states each set with either of a remote control attribute and a local control attribute as an attribute; and
processing circuitry to cause a remote device in a remote environment for a control target device to perform an output value generating process of generating an output value to the control target device, when the attribute of a current state of the state machine is the remote control attribute, and to cause a local device in a local environment for the control target device to perform the output value generating process, when the attribute of the current state of the state machine is the local control attribute, wherein
the state machine includes a remote state machine managed at the remote device and a local state machine managed at the local device,
the remote state machine making a state transition among the plurality of states each set with either of the remote control attribute and the local control attribute as the attribute,
the local state machine including a plurality of states identical to the plurality of states included in the remote state machine, and making a state transition in synchronization with the remote state machine, with an attribute identical to that of a corresponding state of the remote state machine being set to each state,
the processing circuitry includes
remote processing circuitry which operates at the remote device and manages the remote state machine, and
local processing circuitry which operates at the local device and manages the local state machine,
the remote processing circuitry causes the remote state machine to perform the output value generating process, when the attribute of the current state of the remote state machine is the remote control attribute, and
the local processing circuitry causes the local state machine to perform the output value generating process, when the attribute of the current state of the local state machine is the local control attribute.

2. The control system according to claim 1, wherein
the processing circuitry,
when the attribute of the current state of the state machine is the remote control attribute, causes the remote device to perform the output value generating process using an input value from the control target device, and
when the attribute of the current state of the state machine is the local control attribute, causes the local device to perform the output value generating process using the input value from the control target device.

3. The control system according to claim 1, wherein
the remote processing circuitry, when the current state of the remote state machine is the remote control attribute, notifies the local processing circuitry of an output value generated at the remote state machine, and
the local processing circuitry,
when the attribute of the current state of the local state machine is the remote control attribute, transmits, to the control target device, the output value of which notification is provided from the remote processing circuitry, and
when the attribute of the current state of the local state machine is the local control attribute, transmits, to the control target device, an output value generated at the local state machine.

4. The control system according to claim 3, wherein
the local processing circuitry
repeatedly receives an input value from the control target device, and
notifies the remote processing circuitry of the received input value whenever receiving the input value from the control target device,
the remote processing circuitry, when the attribute of the current state of the remote state machine is the remote control attribute, causes the remote state machine to perform the output value generating process using the input value from the control target device, and
the local processing circuitry,
when the attribute of the current state of the local state machine is the remote control attribute, transmits, to the control target device, the output value of which notification is provided from the remote processing circuitry, and
when the attribute of the current state of the local state machine is the local control attribute, causes the local state machine to perform the output value generating process using the input value from the control target device and transmits the output value generated at the local state machine to the control target device.

5. The control system according to claim 4, wherein
the remote processing circuitry, when the attribute of the current state of the remote state machine is the remote control attribute, causes the remote state machine to decide a state transition destination based on the input value from the control target device, causes a state of the remote state machine to make a transition to the state transition destination, and notifies the local processing circuitry of the state transition destination, and
the local processing circuitry, when notified of the state transition destination from the remote processing circuitry, causes a state of the local state machine to make a transition to the state transition destination of which notification is provided from the remote processing circuitry.

6. The control system according to claim 4, wherein
the local processing circuitry, when the attribute of the current state of the local state machine is the local control attribute, causes the local state machine to decide a state transition destination based on the input value from the control target device, causes a state of the local state machine to make a transition to the state transition destination, and notifies the remote processing circuitry of the state transition destination, and
the remote processing circuitry, when notified of the state transition destination from the local processing circuitry, causes a state of the remote state machine to make a transition to the state transition destination of which notification is provided from the local processing circuitry.

7. The control system according to claim 1, wherein
the remote processing circuitry generates a program for causing the local state machine to perform the output value generating process as a local state machine program and outputs the generated local state machine program to the local processing circuitry, and
the local processing circuitry sets the local state machine program to the local state machine.

8. The control system according to claim 4, wherein
a required response time is specified to each state of the plurality of states included in the remote state machine, the required response time being a time required in the local device from reception of the input value from the control target device to transmission of the output value to the control target device, and
the remote processing circuitry sets attributes of a predetermined number of states among the plurality of states as the local control attributes in order in which the required response time is shorter, and sets attributes of remaining states among the plurality of states as the remote control attributes.

9. The control system according to claim 4, wherein
a required response time is specified to each state of the plurality of states included in the remote state machine, the required response time being a time required in the local device from reception of the input value from the control target device to transmission of the output value to the control target device, and
the remote processing circuitry sets an attribute of a state among the plurality of states, the state for which it is predicted that the required response time is not satisfied based on communication quality of a communication line to be used when the remote device communicates with the local device, as the local control attribute, and sets attributes of remaining states among the plurality of states as the remote control attributes.

10. The control system according to claim 1, wherein
the local device
is connected to the remote device via a communication line for which prediction of communication delay and jitter is difficult, and
is connected to the control target device via a communication line for which the prediction of the communication delay and the jitter is not difficult.

11. The control system according to claim 4, wherein
the local processing circuitry receives the input value from the control target device from an input/output device connected to the control target device.

12. The control system according to claim 1, wherein
the local device is a gateway which is connected to the remote device and an input/output device connected to the control target device, and relays communication between the input/output device and the remote device.

13. A local device in a local environment for a control target device, the local device comprising:
a local state machine to make a state transition among a plurality of states each set with either of a remote control attribute and a local control attribute as an attribute; and
processing circuitry
to receive an input value signal for providing notification of an input value from the control target device;
to receive an output packet for providing notification of an output value to the control target device from a remote device in a remote environment for the control target device; and
when the attribute of a current state of the local state machine is the remote control attribute, to transmit to the control target device, an output value signal for providing notification of the output value to the control target device of which notification is provided by the output packet, and, when the attribute of the current state of the local state machine is the local control attribute, to output, to the local state machine, the input value from the control target device of which notification is provided by the input value signal to cause the local state machine to generate an output value to the control target device, and to transmit to the control target device, an output value signal for providing notification of the output value to the control target device generated by the local state machine.

14. A remote device in a remote environment for a control target device, the remote device comprising:
a primitive state machine to make a state transition among a plurality of states each set with either of a remote control attribute and a local control attribute as an attribute; and
processing circuitry
to receive an input packet for providing notification of an input value from the control target device transmitted from a local device in a local environment for the control target device; and
when the attribute of a current state of the primitive state machine is the remote control attribute, to output, to the primitive state machine, the input value from the control target device of which notification is provided by the input packet to cause the primitive state machine to generate an output value to the control target device, to transmit to the local device, an output packet for providing notification of the output value to the control target device generated by the primitive state machine, and to cause the local device to transmit, to the control target device, an output value signal for providing notification of the output value of which notification is provided by the output packet.
